(19) United States
(12) Patent Application Publication
(10) Pub. No.: US 2024/0270009 A1
(43) Pub. Date: Aug. 15, 2024

(54) OPTICAL EFFECT LAYERS COMPRISING MAGNETIC OR MAGNETIZABLE PIGMENT PARTICLES AND METHODS FOR PRODUCING SAID OPTICAL EFFECT LAYERS

(71) Applicant: SICPA HOLDING SA, Prilly (CH)

(72) Inventors: Evgeny LOGINOV, Renens (CH); Andrea CALLEGARI, Ecublens (CH); Raynald DEMANGE, Montagny-près-Yverdon (CH); Christophe BAUDRAZ, Agiez (CH); Dominique FAVRE, Suchy (CH)

(21) Appl. No.: 18/568,586

(22) PCT Filed: Jun. 3, 2022
(86) PCT No.: PCT/EP2022/065193

§ 371 Date: Dec. 8, 2023

(30) Foreign Application Priority Data
Jun. 11, 2021 (EP) 21178995.3

(51) Int. Cl. B41M 3/14; B41M 1/04; B41M 7/00; B42D 25/369; C09D 11/037; C09D 11/101; C09D 11/107; C09D 11/50

(52) U.S. Cl. CPC B41M 3/14; B41M 1/04; B41M 7/0072; B42D 25/369; C09D 11/037; C09D 11/101; C09D 11/107; C09D 11/50

(57) ABSTRACT

The invention relates to the field of the protection of security documents such as for example banknotes and identity documents against counterfeit and illegal reproduction. In particular, the present invention provides security documents and decorative articles comprising one or more optical effect layers (OELs) and methods for producing said OELs, said OELs comprising magnetically oriented platelet-shaped magnetic or magnetizable pigment particles in an at least partially cured coating layer (x40)

### FIELD OF THE INVENTION

The present invention relates to the field of optical effect layers (OELs) comprising magnetically oriented magnetic or magnetizable pigment particles. In particular, the present invention provides security documents and decorative articles comprising one or more optical effect layers (OELs) and methods for producing said OELs and the use of said OELs as anti-counterfeit means on security documents or security articles as well as decorative purposes.

### BACKGROUND OF THE INVENTION

It is known in the art to use inks, compositions, coatings or layers containing oriented magnetic or magnetizable pigment particles, particularly also optically variable magnetic or magnetizable pigment particles, for the production of security elements, e.g. in the field of security documents. Coatings or layers comprising oriented magnetic or magnetizable pigment particles are disclosed for example in U.S. Pat. Nos. 2,570,856; 3,676,273; 3,791,864; 5,630,877 and 5,364,689. Coatings or layers comprising oriented magnetic color-shifting pigment particles, resulting in particularly appealing optical effects, useful for the protection of security documents, have been disclosed in WO 2002/090002 A2 and WO 2005/002866 A1.

Security features, e.g. for security documents, can generally be classified into “covert” security features on the one hand, and “overt” security features on the other hand. The protection provided by covert security features relies on the principle that such features are difficult to detect, typically requiring specialized equipment and knowledge for detection, whereas “overt” security features rely on the concept of being easily detectable with the unaided human senses, e.g. such features may be visible and/or detectable via the tactile sense while still being difficult to produce and/or to copy. However, the effectiveness of overt security features depends to a great extent on their easy recognition as a security feature.

Magnetic or magnetizable pigment particles in printing inks or coatings allow for the production of magnetically induced images, designs and/or patterns through the application of a correspondingly structured magnetic field, inducing a local orientation of the magnetic or magnetizable pigment particles in the not yet hardened/cured (i.e. wet) coating, followed by the hardening of the coating. The result is a fixed and stable magnetically induced image, design or pattern. Materials and technologies for the orientation of magnetic or magnetizable pigment particles in coating compositions have been disclosed for example in U.S. Pat. Nos. 2,418,479; 2,570,856; 3,791,864, DE 2006848-A, U.S. Pat. Nos. 3,676,273, 5,364,689, 6,103,361, EP 0 406 667 B1; US 2002/0160194; US 2004/0009309; EP 0 710 508 A1; WO 2002/09002 A2; WO 2003/000801 A2; WO 2005/002866 A1; WO 2006/061301 A1. In such a way, magnetically induced patterns which are highly resistant to counterfeit can be produced. The security element in question can only be produced by having access to both, the magnetic or magnetizable pigment particles or the corresponding ink, and the particular technology employed to print said ink and to orient said pigment in the printed ink.

According to the magnetic orientation pattern of the magnetic or magnetizable pigment particles an optical effect layer (OEL) and to the observation direction, said OEL may display bright and dark areas. The optical properties of specific zones of the OEL are directly dependent on the orientation of the magnetic or magnetizable pigment particles in the coating layer forming said OEL.

EP 2 024 451 B2 discloses coating compositions consisting of volatile components (S) and non-volatile components, including in particular UV curable compounds, the latter consisting of an ink vehicle (I) and magnetically orientable optically variable interference pigment (P), characterized in that the ratio of the volume of the ink vehicle (V(I) to the volume of the pigment (V(P)) is higher than 5.0 for producing magnetically induced images (i.e. optical effect layers). EP 2 024 451 B2 further discloses that the optical effect layer is thicker than d50/3, wherein d50 is the mean diameter of the magnetically orientable optically variable interference pigment. In particular, EP 2 024 451 B2 discloses an improved method using the specific ratio of the volume of the ink vehicle (V(I)) to the volume of the pigment (V(P)) and the specific ratio of the thickness with respect to the d50 value so as to produce optical effect layers compared to conventional solvent based compositions which have been considered to be not suitable due to the vertical shrinking of the printed ink layer during the drying step.

EP 1 819 525 B1 and U.S. Pat. No. 8,025,952 disclose optical effect layers particles magnetically oriented according to a pattern known as Venetian-blind. The disclosed optical effect layers comprise at least one zone of magnetically oriented platelet-shaped magnetic or magnetizable pigment particles which are co-parallel. The magnetically oriented pigment particles have their magnetic axis parallel to each other and parallel to a plane, wherein said plane is not parallel to the substrate onto which said particles are applied and have substantially the same elevation angle of at least 30° with respect to the plane of the substrate.

WO 2020/173693 A1 discloses methods of authenticating with a portable device optical effects layers such as those disclosed in EP 1 819 525 B1 and U.S. Pat. No. 8,025,952.

The optical effect layers disclosed in EP 1 819 525 B1, U.S. Pat. No. 8,025,952 and WO 2020/173693 A1 are typically produced by using the coating compositions disclosed in EP 2 024 451 B1.

There remains a need for improved methods to produce optical effect layers (OELs) comprising magnetically oriented platelet-shaped magnetic or magnetizable pigment particles on substrates in terms of efficiency and freedom to choose magnetic-field generating devices to orient particles in coating layers so as to have one or more areas with neighboring magnetically oriented platelet-shaped magnetic or magnetizable pigment particles being substantially parallel to each other.

### SUMMARY OF THE INVENTION

Accordingly, it is an object of the present invention to overcome the deficiencies of the prior art.

This is achieved by the provision of methods for producing the optical effect layers (OELs) described herein and optical effect layers (OELs) obtained thereof.

Described herein are methods for producing an optical effect layer (OEL) on a substrate (x20) having a two-dimensional surface, said method comprising the steps of:
a) applying on the substrate (x20) surface a radiation curable coating composition comprising platelet-shaped magnetic or magnetizable pigment particles having a main axis X and having a d50 value, said radiation curable coating composition being in a first, liquid state so as to form a coating layer (x10);
b) exposing the coating layer (x10) to a magnetic field of a magnetic-field generating device (x30) in one or more areas (A, A′, Aⁱ′) of said magnetic field so as to orient at least a part of the platelet-shaped magnetic or magnetizable pigment particles,
wherein the substrate (x20) carrying the coating layer (x10) is provided in said one or more areas (A, A′, Aⁱ′) and wherein an angle α formed by the two-dimensional surface of the substrate (x20) at the positions of the particles and a tangent to magnetic field lines of the magnetic field within the one or more areas (A, A′, Aⁱ′) is larger than or equal to 12° and smaller than or equal to about 75° (12°≤|α|≤75°) or larger than or equal to 105° and smaller than or equal to 168° (105°≤|α|≤168°);
c) partially simultaneously with or subsequently to step b), a step of at least partially curing the coating layer (x10) with a curing unit (x50) so as to fix the position and orientation of the platelet-shaped magnetic or magnetizable pigment particles in the coating layer (x10) so as to produce an at least partially cured coating layer (x40) having a thickness T,
wherein the thickness T of the at least partially cured coating layer (x40) is smaller than the d50 value of the platelet-shaped magnetic or magnetizable pigment particles, and wherein neighboring magnetically oriented platelet-shaped magnetic or magnetizable pigment particles have at least their main axis X substantially parallel to each other in one or more regions (x40-a, x40-b) of the at least partially cured coating layer (x40).

Also described herein are optical effect layers (OEL) comprising an at least partially cured layer (x40) having a thickness T and made from a radiation curable coating composition comprising magnetically oriented platelet-shaped magnetic or magnetizable pigment particles having a main axis X and having a d50 value, wherein the thickness T of the at least partially cured coating layer (x40) is smaller than the d50 value of the platelet-shaped magnetic or magnetizable pigment particles, and wherein, in one or more regions (x40-a, x40-b) of said at least partially cured layer (x40), neighboring magnetically oriented platelet-shaped magnetic or magnetizable pigment particles have at least their main axis X substantially parallel to each other

Contrary to what is disclosed in EP 2 024 451 B2, it has been shown that the use of the claimed specific relationship between the thickness of the at least partially cured coating layer (x40) (i.e. the thickness of the optical effect layer) described herein and the d50 value of the platelet-shaped magnetic or magnetizable pigment particles (T<d50) as well as the specific claimed angle α values, and preferably the relationship between the thickness and the angle α values (T<d50*(sin α)) for the claimed methods allows to freely chose the magnetic-field generating device irrespective of their magnetic field homogeneity/inhomogeneity to produce said optical effect layers comprising one or more regions (x40-a, x40-b) of the at least partially cured coating layer (x40) wherein neighboring magnetically oriented platelet-shaped magnetic or magnetizable pigment particles have at least their main axis X substantially parallel to each other. Furthermore, the present invention advantageously allows to produce optical effect layers (OELs) with a wide surface uniform pigment orientation.

### BRIEF DESCRIPTION OF DRAWINGS

The security documents or articles comprising the one or more optical effect layers (OELs) described herein and the methods described herein for producing said OELs on substrates (x20) are now described in more details with reference to the drawings and to particular embodiments, wherein

FIG. 1 schematically illustrates a platelet-shaped magnetic or magnetizable pigment particle with its main axis X and its main axis Y.

FIG. 2A-2H illustrate cross-sections of an OEL comprising one or more at least partially cured coating layer (240, 241) having a thickness T, T′ and comprising magnetically oriented platelet-shaped magnetic or magnetizable pigment particles incorporated therein.

FIG. 2A schematically illustrates a cross-section of an OEL comprising a single at least partially cured coating layer (240) having a thickness T and comprising magnetically oriented platelet-shaped magnetic or magnetizable pigment particles incorporated therein, wherein substantially all the platelet-shaped magnetic or magnetizable pigment particles in one or more regions have substantially the same elevation angle γ and wherein the particles have a d50 value larger than T.

FIG. 2B schematically illustrates a cross-section of an OEL comprising a single at least partially cured coating layer (240) having a thickness T comprising platelet-shaped magnetic or magnetizable pigment particles in one or more first regions (240-a) and platelet-shaped magnetic or magnetizable pigment particles in one or more second regions (240-b), wherein substantially all the platelet-shaped magnetic or magnetizable pigment particles in the one or more first regions (240-a) have substantially the same elevation angle γ and substantially all the platelet-shaped magnetic or magnetizable pigment particles in the one or more second regions (240-b) have substantially the same additional elevation angle γ′, said elevation angle γ and additional elevation angle γ′ being different from each other and/or being not coplanar and wherein the particles have a d50 value larger than T.

FIG. 2C schematically illustrates a cross-section of an OEL comprising an at least partially cured first coating layer (240) having a thickness T and comprising magnetically oriented first platelet-shaped magnetic or magnetizable pigment particles incorporated therein and an at least partially cured second coating layer (241) having a thickness T′ with magnetically oriented second platelet-shaped magnetic or magnetizable pigment particles incorporated therein, said at least partially cured second coating layer (241) at least partially overlapping the at least partially cured first coating layer (240), wherein substantially all the first platelet-shaped magnetic or magnetizable pigment particles in the at least partially cured coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second pigment particles in the at least partially cured second coating layer (241) have a d50 value larger than T′.

FIG. 2D schematically illustrates a cross-section of an OEL comprising an at least partially cured first coating layer (240) having a thickness T with magnetically oriented first platelet-shaped magnetic or magnetizable pigment particles incorporated therein and an at least partially cured second coating layer (241) having a thickness T′ with magnetically oriented second platelet-shaped magnetic or magnetizable pigment particles incorporated therein, said at least partially cured second coating layer (241) fully overlapping the at least partially cured first coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2E-F schematically illustrate a cross-section of an OEL comprising an at least partially cured first coating layer (240) having a thickness T with magnetically oriented first platelet-shaped magnetic or magnetizable pigment particles incorporated therein and an at least partially cured second coating layer (241) having a thickness T′ with magnetically oriented second platelet-shaped magnetic or magnetizable pigment particles incorporated therein, said at least partially cured second coating layer (241) being adjacent (FIG. 2E) to the at least partially cured first coating layer (240) or being spaced apart (FIG. 2F) from the at least partially cured first coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2G-H schematically illustrate a cross-section of an OEL comprising an at least partially cured first coating layer (240) having a thickness T with magnetically oriented first platelet-shaped magnetic or magnetizable pigment particles incorporated therein and an at least partially cured second coating layer (241) having a thickness T′ with magnetically oriented second platelet-shaped magnetic or magnetizable pigment particles incorporated therein, said at least partially cured second coating layer (241) being at least partially (FIG. 2G) or fully (FIG. 2H) overlapping the at least partially cured first coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIGS. 3A-B and 3D schematically illustrate a cross-section of a suitable magnetic-field generating device (330) for orienting platelet-shaped magnetic or magnetizable pigment particles in a coating layer (310) on a substrate (320), said device (330) consisting of a bar dipole magnet, wherein the platelet-shaped magnetic or magnetizable pigment particles are exposed to the magnetic field (magnetic field lines shown as lines with arrows pointing from the North Pole to the South Pole) of the magnetic field of the magnetic-field generating device (330) in two areas wherein the magnetic field is substantially inhomogeneous (shown as A and A′).

FIG. 3C schematically illustrates a cross-section of a suitable magnetic-field generating device (330) for orienting platelet-shaped magnetic or magnetizable pigment particles in either a single discontinuous coating layer (310) having two regions (310-a and 310-b) or two coating layers (310-a and 310-b) on a substrate (320), said device (330) consisting of a bar dipole magnet, wherein the platelet-shaped magnetic or magnetizable pigment particles of the two regions (310-a and 310-b) are exposed to the magnetic field (magnetic field lines shown as lines with arrows pointing from the North Pole to the South Pole) of the magnetic field of magnetic-field generating device (330), each in one area wherein the magnetic field is substantially inhomogeneous (shown as A and A′).

FIG. 4 schematically illustrates a suitable magnetic-field generating device (430) for orienting platelet-shaped magnetic or magnetizable pigment particles in a coating layer (410) on a substrate (420), said device (430) consisting of two bar dipole magnets (M1, M2) having a same magnetic direction and an iron yoke (Y), wherein the platelet-shaped magnetic or magnetizable pigment particles are exposed to the magnetic field (magnetic field lines shown as lines with arrows pointing from the North Pole to the South Pole) of the magnetic field of the bar dipole magnet (430) in one area wherein the magnetic field is substantially homogeneous (shown as a dotted rectangle A) and wherein the substrate (420) carrying the coating layer (410) is provided in said area A at the specific angle α.

FIG. 5A-B illustrates the variation of the elevation angle γ of platelet-shaped magnetic or magnetizable pigment particles in an at least partially cured coating layer (Examples E1-E2 and Comparative Examples C1-C2) that having been magnetically oriented with the magnetic field of magnetic-field generating device shown in FIG. 3A, wherein the x-axis (in mm) corresponds to the distance from the edge of the at least partially cured layer (x40), the value of 15 mm corresponding to the center of the magnetic field generating device shown in FIG. 3A and the center of the at least partially cured layer (x40).

FIG. 6 schematically illustrates a magnetic-field generating device (630) disclosed in the co-pending application EP 20194060.8, wherein said device is used for orienting platelet-shaped magnetic or magnetizable pigment particles in a coating layer (610) on a substrate (620), said device (630) consisting of a bar dipole magnet, wherein the platelet-shaped magnetic or magnetizable pigment particles are exposed to the magnetic field (magnetic field lines shown as lines with arrows pointing from the North Pole to the South Pole) of the magnetic field of magnetic-field generating device (630) in one area wherein the magnetic field is substantially homogeneous (shown as B), wherein the substrate (620) carrying the coating layer (610) is provided in said area B wherein the magnetic field is substantially homogeneous with an angle α formed by the coating layer (610) and a tangent to magnetic field lines of the magnetic field within the area B wherein the magnetic field is substantially homogeneous, being about 30°.

The magnetic field lines (shown as lines with arrows pointing from the North Pole to the South Pole) of the magnetic field of magnetic-field generating device (x30) shown in the figures for illustration purpose have been obtained by simulation, said magnetic field simulations have been performed with the software Vizimag 3.19.

### DETAILED DESCRIPTION

### Definitions

The following definitions are to be used to interpret the meaning of the terms discussed in the description and recited in the claims.

As used herein, the term “at least one” is meant to define one or more than one, for example one or two or three.

As used herein, the terms “about” and “substantially” mean that the amount or value in question may be the specific value designated or some other value in its neighborhood. Generally, the terms “about” and “substantially” denoting a certain value is intended to denote a range within ±5% of the value. As one example, the phrase “about 100” denotes a range of 100±5, i.e. the range from 95 to 105. Generally, when the term “about” is used, it can be expected that similar results or effects according to the invention can be obtained within a range of +5% of the indicated value.

The terms “substantially parallel” refer to deviating not more than 2° as averaged on a coating layer surface of at least 1 mm², or on at least about 100 particles from parallel alignment.

As used herein, the term “and/or” means that either all or only one of the elements of said group may be present. For example, “A and/or B” shall mean “only A, or only B, or both A and B”. In the case of “only A”, the term also covers the possibility that B is absent, i.e. “only A, but not B”.

The term “comprising” as used herein is intended to be non-exclusive and open-ended. Thus, for instance a coating composition comprising a compound A may include other compounds besides A. However, the term “comprising” also covers, as a particular embodiment thereof, the more restrictive meanings of “consisting essentially of” and “consisting of”, so that for instance “a mixture comprising A, B and optionally C” may also (essentially) consist of A and B, or (essentially) consist of A, B and C.

The term “optical effect layer (OEL)” as used herein denotes a coating layer that comprises oriented magnetic or magnetizable pigment particles, wherein said magnetic or magnetizable pigment particles are oriented by a magnetic field and wherein the oriented magnetic or magnetizable pigment particles are fixed/frozen in their orientation and position (i.e. after curing) so as to form a magnetically induced image.

The term “coating composition” refers to any composition which is capable of forming an optical effect layer (OEL) on a solid substrate and which can be applied preferably but not exclusively by a printing method. The coating composition comprises the platelet-shaped magnetic or magnetizable pigment particles described herein and the binder described herein.

As used herein, the term “wet” refers to a coating layer which is not yet at least partially cured, for example a coating in which the platelet-shaped magnetic or magnetizable pigment particles are still able to change their positions and orientations under the influence of external forces acting upon them.

The term “security document” refers to a document which is usually protected against counterfeit or fraud by at least one security feature. Examples of security documents include without limitation value documents and value commercial goods.

The term “security feature” is used to denote an image, pattern or graphic element that can be used for authentication purposes.

Where the present description refers to “preferred” embodiments/features, combinations of these “preferred” embodiments/features shall also be deemed as disclosed as long as this combination of “preferred” embodiments/features is technically meaningful.

The present invention provides methods for producing one or more optical effect layers (OELs) and optical effect layers (OELs) obtained thereof, said OELs comprising platelet-shaped magnetic or magnetizable pigment particles on a substrate (x20) having a two-dimensional surface, wherein said OELs are based on magnetically oriented platelet-shaped magnetic or magnetizable pigment particles incorporated in an at least partially cured coating layer (x40).

The present invention further provides OELs comprising the at least partially cured layer (x40) having a thickness T and made from the radiation curable coating composition comprising magnetically oriented platelet-shaped magnetic or magnetizable pigment particles having a main axis X and having a d50 value as described herein, wherein the thickness T of the at least partially cured coating layer (x40) is smaller than the d50 value of the platelet-shaped magnetic or magnetizable pigment particles, and wherein, in one or more regions (x40-a, x40-b) of said at least partially cured layer (x40), neighboring magnetically oriented platelet-shaped magnetic or magnetizable pigment particles have at least their main axis X substantially parallel to each other.

The present invention further provides security documents and decorative articles comprising the substrate (x20) and the one or more optical effect layers (OELs) on said substrate (x20) described herein.

Typical examples of decorative articles include without limitation luxury goods, cosmetic packaging, automotive parts, electronic/electrical appliances, furniture and fingernail articles. Alternatively, the one or more OELs described herein may be comprised onto an auxiliary substrate such as for example a label and consequently transferred to a decorative article in a separate step.

Security documents include without limitation value documents and value commercial goods. Typical example of value documents include without limitation banknotes, deeds, tickets, checks, vouchers, fiscal stamps and tax labels, agreements and the like, identity documents such as passports, identity cards, visas, driving licenses, bank cards, credit cards, transactions cards, access documents or cards, entrance tickets, public transportation tickets, academic diploma or titles and the like, preferably banknotes, identity documents, right-conferring documents, driving licenses and credit cards. The term “value commercial good” refers to packaging materials, in particular for cosmetic articles, nutraceutical articles, pharmaceutical articles, alcohols, tobacco articles, beverages or foodstuffs, electrical/electronic articles, fabrics or jewelry, i.e. articles that shall be protected against counterfeiting and/or illegal reproduction in order to warrant the content of the packaging like for instance genuine drugs. Examples of these packaging materials include without limitation labels, such as authentication brand labels, tamper evident labels and seals. It is pointed out that the disclosed substrates, security documents and decorative articles are given exclusively for exemplifying purposes, without restricting the scope of the invention. Alternatively, the one or more OELs described herein may be comprised onto an auxiliary substrate such as for example a security thread, security stripe, a foil, a decal, a window or a label and consequently transferred to a security document in a separate step.

The shape of the one or more OELs described herein may be continuous or discontinuous. According to one embodiment, the shape of the one or more OELs independently represent one or more indicia, dots and/or lines. For embodiments wherein the security documents and decorative articles comprise more than one, i.e. two, three, etc., OELs, said OELs may be adjacent to each other, spaced apart from each other, or partially or fully overlapping each other.

The platelet-shaped magnetic or magnetizable pigment particles are comprised in the radiation curable coating composition described herein as well as the coating layer (x10) as well as the at least partially cured coating layer (x40). As mentioned herein, the methods described herein comprise the step c) of at least partially curing the coating layer (x10) to a second state, where the platelet-shaped magnetic or magnetizable pigment particles are fixed in their current positions and orientations and can no longer move nor rotate within said layer. As used herein, by “at least partially curing the coating layer (x10)”, it means that the platelet-shaped magnetic or magnetizable pigment particles are fixed/frozen in their adopted positions and orientations and cannot move and rotate anymore (also referred in the art as “pinning” of the particles).

As mentioned therein, the one or more OELs described herein comprise the magnetically oriented platelet-shaped magnetic or magnetizable pigment particles in the at least partially cured coating layer (x40). Preferably, the platelet-shaped magnetic or magnetizable pigment particles described herein are present in an amount from about 5 wt-% to about 40 wt-%, more preferably about 10 wt-% to about 30 wt-%, the weight percentages being based on the total weight of the at least partially cured coating layer. Preferably, the platelet-shaped magnetic or magnetizable pigment particles described herein are present in an amount from about 5 wt-% to about 40 wt-%, more preferably about 10 wt-% to about 30 wt-%, the weight percentages being based on the total weight of the radiation curable coating layer described herein.

Platelet-shaped magnetic or magnetizable pigment particles described herein are defined as having, due to their non-spherical shape, non-isotropic reflectivity with respect to an incident electromagnetic radiation for which the cured binder material is at least partially transparent. As used herein, the term “non-isotropic reflectivity” denotes that the proportion of incident radiation from a first angle that is reflected by a particle into a certain (viewing/observation) direction (a second angle) is a function of the orientation of the particles, i.e. that a change of the orientation of the particle with respect to the first angle can lead to a different magnitude of the reflection to the viewing/observation direction. Preferably, the platelet-shaped magnetic or magnetizable pigment particles described herein have a non-isotropic reflectivity with respect to incident electromagnetic radiation in some parts or in the complete wavelength range of from about 200 to about 2500 nm, more preferably from about 400 to about 700 nm, such that a change of the particle's orientation results in a change of reflection by that particle into a certain direction. As known by the man skilled in the art, the magnetic or magnetizable pigment particles described herein are different from conventional pigments, in that said conventional pigment particles exhibit the same color and reflectivity, independent of the particle orientation, whereas the magnetic or magnetizable pigment particles described herein exhibit either a reflection or a color, or both, that depend on the particle orientation. In contrast to needle-shaped pigment particles which can be considered as one-dimensional particles, platelet-shaped pigment particles have an X-axis and a Y-axis defining a plane of predominant extension of the particles (FIG. 1). In other words, and as shown in FIG. 1, platelet-shaped pigment particles may be considered to be two-dimensional particles due to the large aspect ratio of their dimensions, wherein the dimensions X and Y are substantially larger than dimension Z. Platelet-shaped pigment particles are also referred in the art as oblate particles or flakes. Such pigment particles may be described with a main axis X corresponding to the longest dimension crossing the pigment particle and a second main axis Y perpendicular to X which also lies within said pigment particles.

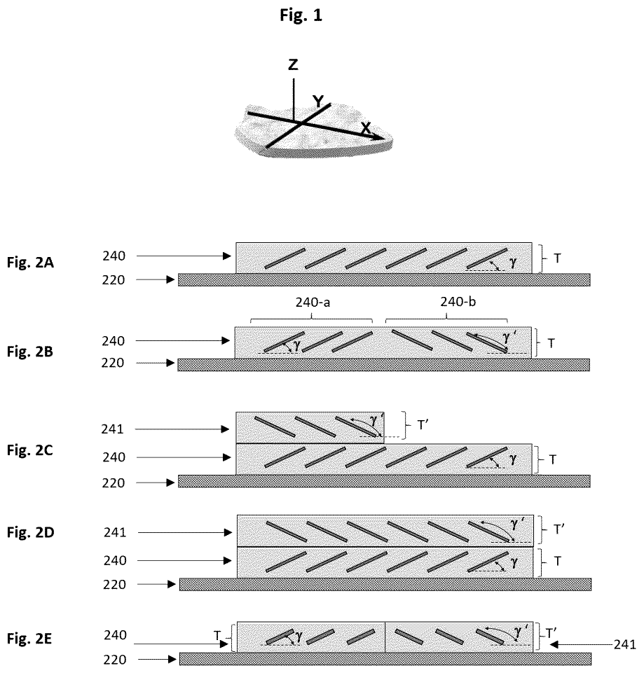

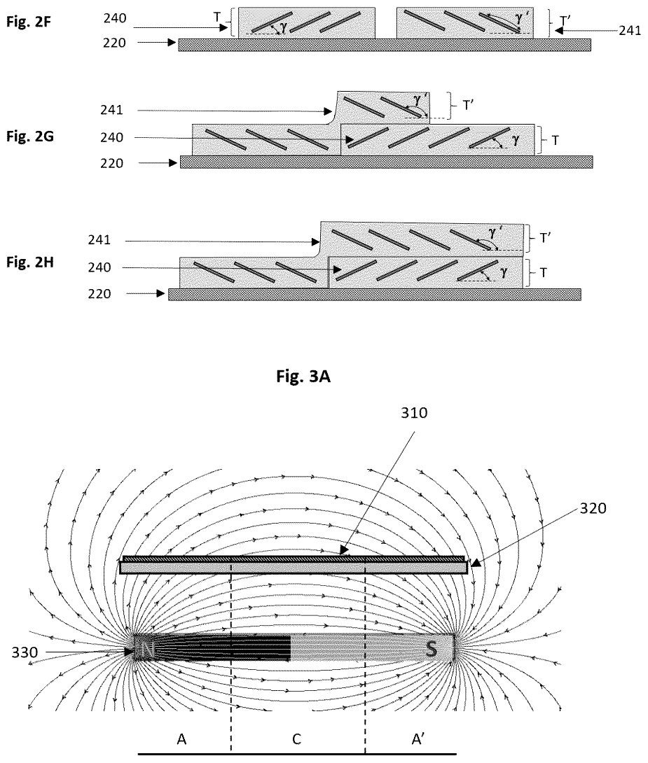

The OELs described herein comprise magnetically oriented or platelet-shaped magnetic or magnetizable pigment particles in the at least partially cured coating layer (x40) described herein, wherein the orientation of the platelet-shaped magnetic or magnetizable pigment particles is defined by a platelet vector which is the vector parallel to the main axis X of the particle, wherein the platelet vectors of neighboring platelet-shaped magnetic or magnetizable pigment particles are substantially parallel to each other (see for example FIG. 2A), and wherein the platelet vectors of the platelet-shaped magnetic or magnetizable pigment particles are angled with respect to the two-dimensional surface of the substrate (x20) at the positions of the particles by the elevation angle γ described herein.

The platelet-shaped magnetic or magnetizable pigment particles in the at least partially cured coating layer (x40) are oriented as described herein with the elevation angle γ described herein. In other words, the elevation angle is formed by the main axis X of the platelet-shaped magnetic or magnetizable pigment particles and the two-dimensional surface of the substrate (x20).

For embodiments wherein the platelet-shaped magnetic or magnetizable pigment particles are mono-axially oriented, the orientation of the platelet-shaped pigment particles is defined by the platelet vector which is the vector parallel to the main axis X of the particle, wherein the platelet vectors of neighboring platelet-shaped magnetic or magnetizable pigment particles are substantially parallel to each other; i.e. only the main axes X of neighboring platelet-shaped magnetic or magnetizable pigment particles are substantially parallel to each other (in other words, neighboring platelet-shaped magnetic or magnetizable pigment particles have a substantially same elevation angle γ).

For embodiments wherein the platelet-shaped magnetic or magnetizable pigment particles are bi-axially oriented, the orientation of the platelet-shaped pigment particles is defined by the platelet vector which is the vector parallel to the main axis X of the particle, wherein the platelet vectors of neighboring platelet-shaped magnetic or magnetizable pigment particles are parallel to each other and is further defined by a second platelet vector which is the vector parallel to the second axis Y of the particle, wherein the platelet vectors of neighboring platelet-shaped magnetic or magnetizable pigment particles are parallel to each other and the second platelet vectors of said neighboring platelet-shaped magnetic or magnetizable pigment particles are parallel to each other.

Suitable examples of platelet-shaped magnetic or magnetizable pigment particles described herein include without limitation pigment particles comprising a magnetic metal selected from the group consisting of cobalt (Co), iron (Fe), and nickel (Ni); a magnetic alloy of iron, manganese, cobalt, nickel or a mixture of two or more thereof; a magnetic oxide of chromium, manganese, cobalt, iron, nickel or a mixture of two or more thereof; or a mixture of two or more thereof. The term “magnetic” in reference to the metals, alloys and oxides is directed to ferromagnetic or ferrimagnetic metals, alloys and oxides. Magnetic oxides of chromium, manganese, cobalt, iron, nickel or a mixture of two or more thereof may be pure or mixed oxides. Examples of magnetic oxides include without limitation iron oxides such as hematite (Fe₂O₃), magnetite (Fe₃O₄), chromium dioxide (CrO₂), magnetic ferrites (MFe₂O₄), magnetic spinels (MR₂O₄), magnetic hexaferrites (MFe₁₂O₁₉), magnetic orthoferrites (RFeOs), magnetic garnets M₃R₂(AO₄)₃, wherein M stands for two-valent metal, R stands for three-valent metal, and A stands for four-valent metal.

Examples of platelet-shaped magnetic or magnetizable pigment particles described herein include without limitation pigment particles comprising a magnetic layer M made from one or more of a magnetic metal such as cobalt (Co), iron (Fe), or nickel (Ni); and a magnetic alloy of iron, cobalt or nickel, wherein said magnetic or magnetizable pigment particles may be multilayered structures comprising one or more additional layers. Preferably, the one or more additional layers are layers A independently made from one or more selected from the group consisting of metal fluorides such as magnesium fluoride (MgF₂), silicon oxide (SiO), silicon dioxide (SiO₂), titanium oxide (TiO₂), and aluminum oxide (Al₂O₃), more preferably silicon dioxide (SiO₂); or layers B independently made from one or more selected from the group consisting of metals and metal alloys, preferably selected from the group consisting of reflective metals and reflective metal alloys, and more preferably selected from the group consisting of aluminum (Al), chromium (Cr), and nickel (Ni), and still more preferably aluminum (Al); or a combination of one or more layers A such as those described hereabove and one or more layers B such as those described hereabove. Typical examples of the platelet-shaped magnetic or magnetizable pigment particles being multilayered structures described hereabove include without limitation A/M multilayer structures, A/M/A multilayer structures, A/M/B multilayer structures, A/B/M/A multilayer structures, A/B/M/B multilayer structures, A/B/M/B/A/multilayer structures, B/M multilayer structures, B/M/B multilayer structures, B/A/M/A multilayer structures, B/A/M/B multilayer structures, B/A/M/B/A/multilayer structures, B/A/B/M/B/A/B multilayer structures wherein the layers A, the magnetic layers M and the layers B are chosen from those described hereabove.

According to one embodiment, at least a part of the preferred platelet-shaped, magnetic or magnetizable particles is constituted by platelet-shaped optically variable magnetic or magnetizable pigment particles. Optically variable pigments refer to pigments exhibiting a change of lightness or a combination of a change of lightness and a change of hue with changing viewing angle. According to one embodiment, at least a part of the platelet-shaped, magnetic or magnetizable particles is constituted by particles exhibiting a metallic color, more preferably a silver color or a gold color.

In addition to the overt security provided by the colorshifting property of the optically variable magnetic or magnetizable pigment particles, which allows easily detecting, recognizing and/or discriminating an article or security document carrying an ink, coating composition, or coating layer comprising the optically variable magnetic or magnetizable pigment particles described herein from their possible counterfeits using the unaided human senses, the optical properties of the optically variable magnetic or magnetizable pigment particles may also be used as a machine readable tool for the recognition of the OEL. Thus, the optical properties of the optically variable magnetic or magnetizable pigment particles may simultaneously be used as a covert or semi-covert security feature in an authentication process wherein the optical (e.g. spectral) properties of the pigment particles are analyzed and thus increase the counterfeiting resistance.

The use of platelet-shaped optically variable magnetic or magnetizable pigment particles in an OEL enhances the significance of said OEL as a security feature in security document applications, because such materials are reserved to the security document printing industry and are not commercially available to the public.

Preferably, the platelet-shaped, magnetic or magnetizable pigment particles are selected from the group consisting of magnetic thin-film interference pigment particles, magnetic cholesteric liquid crystal pigment particles, interference coated magnetic pigment particles and mixtures of two or more thereof.

Magnetic thin film interference pigment particles are known to those skilled in the art and are disclosed e.g. in U.S. Pat. No. 4,838,648; WO 2002/073250 A2; EP 0 686 675 B1; WO 2003/000801 A2; U.S. Pat. No. 6,838,166; WO 2007/131833 A1; EP 2 402 401 B1; WO 2019/103937 A1; WO 2020/006286 A1 and in the documents cited therein. Preferably, the magnetic thin film interference pigment particles comprise pigment particles having a five-layer Fabry-Perot multilayer structure and/or pigment particles having a six-layer Fabry-Perot multilayer structure and/or pigment particles having a seven-layer Fabry-Perot multilayer structure and/or pigment particles having a multilayer structure combining one or more multilayer Fabry-Perot structures.

Preferred five-layer Fabry-Perot multilayer structures consist of absorber/dielectric/reflector/dielectric/absorber multilayer structures wherein the reflector and/or the absorber is also a magnetic layer, preferably the reflector and/or the absorber is a magnetic layer comprising nickel, iron and/or cobalt, and/or a magnetic alloy comprising nickel, iron and/or cobalt and/or a magnetic oxide comprising nickel (Ni), iron (Fe) and/or cobalt (Co). Also preferred five-layer Fabry-Perot multilayer structures consist of dielectric/reflector/magnetic/reflector/dielectric multilayer structures, wherein the magnetic layer preferably comprises nickel, iron and/or cobalt, and/or a magnetic alloy comprising nickel, iron and/or cobalt and/or a magnetic oxide comprising nickel (Ni), iron (Fe) and/or cobalt (Co).

Preferred six-layer Fabry-Perot multilayer structures consist of absorber/dielectric/reflector/magnetic/dielectric/absorber multilayer structures.

Preferred seven-layer Fabry Perot multilayer structures consist of absorber/dielectric/reflector/magnetic/reflector/dielectric/absorber multilayer structures such as disclosed in U.S. Pat. No. 4,838,648.

Preferred pigment particles having a multilayer structure combining one or more Fabry-Perot structures are those described in WO 2019/103937 A1 and consist of combinations of at least two Fabry-Perot structures, said two Fabry-Perot structures independently comprising a reflector layer, a dielectric layer and an absorber layer, wherein the reflector and/or the absorber layer can each independently comprise one or more magnetic materials and/or wherein a magnetic layer is sandwich between the two structures. WO 2020/006/286 A1 and EP 3 587 500 A1 disclose further preferred pigment particles having a multilayer structure.

Preferably, the reflector layers described herein are independently made from one or more materials selected from the group consisting of metals and metal alloys, preferably selected from the group consisting of reflective metals and reflective metal alloys, more preferably selected from the group consisting of aluminum (Al), silver (Ag), copper (Cu), gold (Au), platinum (Pt), tin (Sn), titanium (Ti), palladium (Pd), rhodium (Rh), niobium (Nb), chromium (Cr), nickel (Ni), and alloys thereof, even more preferably selected from the group consisting of aluminum (Al), chromium (Cr), nickel (Ni) and alloys thereof, and still more preferably aluminum (Al). Preferably, the dielectric layers are independently made from one or more selected from the group consisting of metal fluorides such as magnesium fluoride (MgF₂), aluminum fluoride (AlF₃), cerium fluoride (CeF₃), lanthanum fluoride (LaF₃), sodium aluminum fluorides (e.g. Na₃AlF₆), neodymium fluoride (NdF₃), samarium fluoride (SmF₃), barium fluoride (BaF₂), calcium fluoride (CaF₂), lithium fluoride (LiF), and metal oxides such as silicon oxide (SiO), silicium dioxide (SiO₂), titanium oxide (TiO2), aluminum oxide (Al₂O₃), more preferably selected from the group consisting of magnesium fluoride (MgF₂) and silicon dioxide (SiO₂) and still more preferably magnesium fluoride (MgF₂). Preferably, the absorber layers are independently made from one or more selected from the group consisting of aluminum (Al), silver (Ag), copper (Cu), palladium (Pd), platinum (Pt), titanium (Ti), vanadium (V), iron (Fe) tin (Sn), tungsten (W), molybdenum (Mo), rhodium (Rh), Niobium (Nb), chromium (Cr), nickel (Ni), metal oxides thereof, metal sulfides thereof, metal carbides thereof, and metal alloys thereof, more preferably selected from the group consisting of chromium (Cr), nickel (Ni), metal oxides thereof, and metal alloys thereof, and still more preferably selected from the group consisting of chromium (Cr), nickel (Ni), and metal alloys thereof. Preferably, the magnetic layer comprises nickel (Ni), iron (Fe) and/or cobalt (Co); and/or a magnetic alloy comprising nickel (Ni), iron (Fe) and/or cobalt (Co); and/or a magnetic oxide comprising nickel (Ni), iron (Fe) and/or cobalt (Co). When magnetic thin film interference pigment particles comprising a seven-layer Fabry-Perot structure are preferred, it is particularly preferred that the magnetic thin film interference pigment particles comprise a seven-layer Fabry-Perot absorber/dielectric/reflector/magnetic/reflector/dielectric/absorber multilayer structure consisting of a Cr/MgF₂/Al/Ni/Al/MgF₂/Cr multilayer structure.

The magnetic thin film interference pigment particles described herein may be multilayer pigment particles being considered as safe for human health and the environment and being based for example on five-layer Fabry-Perot multilayer structures, six-layer Fabry-Perot multilayer structures and seven-layer Fabry-Perot multilayer structures, wherein said pigment particles include one or more magnetic layers comprising a magnetic alloy having a substantially nickel-free composition including about 40 wt-% to about 90 wt-% iron, about 10 wt-% to about 50 wt-% chromium and about 0 wt-% to about 30 wt-% aluminum. Typical examples of multilayer pigment particles being considered as safe for human health and the environment can be found in EP 2 402 401 B1 whose content is hereby incorporated by reference in its entirety.

Suitable magnetic cholesteric liquid crystal pigment particles exhibiting optically variable characteristics include without limitation magnetic monolayered cholesteric liquid crystal pigment particles and magnetic multilayered cholesteric liquid crystal pigment particles. Such pigment particles are disclosed for example in WO 2006/063926 A1, U.S. Pat. Nos. 6,582,781 and 6,531,221. WO 2006/063926 A1 discloses monolayers and pigment particles obtained therefrom with high brilliance and colorshifting properties with additional particular properties such as magnetizability. The disclosed monolayers and pigment particles, which are obtained therefrom by comminuting said monolayers, include a three-dimensionally crosslinked cholesteric liquid crystal mixture and magnetic nanoparticles. U.S. Pat. Nos. 6,582,781 and 6,410,130 disclose platelet-shaped cholesteric multilayer pigment particles which comprise the sequence A¹/B/A², wherein A¹ and A² may be identical or different and each comprises at least one cholesteric layer, and B is an interlayer absorbing all or some of the light transmitted by the layers A¹ and A² and imparting magnetic properties to said interlayer. U.S. Pat. No. 6,531,221 discloses platelet-shaped cholesteric multilayer pigment particles which comprise the sequence A/B and optionally C, wherein A and C are absorbing layers comprising pigment particles imparting magnetic properties, and B is a cholesteric layer.

Suitable interference coated magnetic pigment particles comprise one or more magnetic materials and include without limitation structures consisting of a substrate selected from the group consisting of a core coated with one or more layers, wherein at least one of the core or the one or more layers have magnetic properties. For example, suitable interference coated pigment particles comprise a core made of a magnetic material such as those described hereabove, said core being coated with one or more layers made of one or more metal oxides, or they have a structure consisting of a core made of synthetic or natural micas, layered silicates (e.g. talc, kaolin and sericite), glasses (e.g. borosilicates), silicon dioxides (SiO₂), aluminum oxides (Al₂O₃), titanium oxides (TiO₂), graphites and mixtures of two or more thereof. Furthermore, one or more additional layers such as coloring layers may be present.

The platelet-shaped magnetic or magnetizable pigment particles described herein may be surface treated so as to protect them against any deterioration that may occur in the coating composition and coating layer and/or to facilitate their incorporation in said coating composition and coating layer; typically corrosion inhibitor materials and/or wetting agents may be used.

The methods described herein comprise the step a) of applying on the substrate (x20) surface described herein the radiation curable coating composition comprising the platelet-shaped magnetic or magnetizable pigment particles described herein, said radiation curable coating composition being in a first, liquid state which allows its application as a coating layer (x10) and which is in a not yet at least partially cured (i.e. wet) state wherein the pigment particles can move and rotate within the layer. Since the radiation curable coating composition described herein is to be provided on the substrate (x20) surface, the radiation curable coating composition comprises at least a binder material and the magnetic or magnetizable pigment particles, wherein said composition is in a form that allows its processing on the desired printing or coating equipment. Preferably, said step a) is carried out by a printing process, preferably selected from the group consisting of screen printing, rotogravure printing, flexography printing, more preferably selected from the group consisting of screen printing and flexography printing and still more preferably flexography printing.

Depending on the printing process selected to produce the one or more OELs described herein, suitable viscosity values of the radiation curable coating composition comprising the platelet-shaped magnetic or magnetizable pigment particles are used: screen printing inks have a viscosity between about 50 mPa s and about 3000 mPa s at 25° C., flexography inks have a viscosity between about 50 mPa s and about 2000 mPa s at 25° C., rotogravure inks have a viscosity between about 50 mPa s and about 1000 mPa s at 25°, wherein the viscosity measurements for security inks having a viscosity value between 100 mPa s and 3000 mPa s are carried out with a Brookfield viscometer (model “RVDV-I Prime”), the spindle and rotation speed (rpm) being adapted according to the following viscosity ranges: spindle 21 at 100 rpm for viscosity values between 100 and 500 mPa s; spindle 27 at 100 rpm for viscosity values between 500 mPa s and 2500 mPa s; and spindle 27 at 50 rpm for viscosity values between 2500 mPa s and 3000 mPa s and wherein the viscosity measurements for security inks having a viscosity value between 10 mPa s and 100 mPa s are carried out with a rotational viscosimeter DHR-2 from TA Instruments, having a cone-plane geometry and a diameter of 40 mm, at 25° C. and 1000 s⁻¹.

The methods described herein further comprise the step b) exposing the coating layer (x10) to the magnetic field of the magnetic-field generating device (x30) described herein in one or more areas (A, A′, A′″) of said magnetic field so as to orient at least a part of the platelet-shaped magnetic or magnetizable pigment particles. During the step b) described herein, the substrate (x20) carrying the coating layer (x10) is provided in said one or more areas (A, A′, Aⁱ′, i corresponding to 2, 3, 4, etc.) and wherein the angle ox formed by the two-dimensional surface of the substrate (x20) at the positions of the particles and a tangent to magnetic field lines of the magnetic field within the one or more areas is larger than or equal to 12° and smaller than or equal to 75° (12°≤|α|≤75°) or larger than or equal to 105° and smaller than or equal to 168° (105°≤|α|≤168°).

In addition to the requirement that the thickness T of the at least partially cured coating layer (x40) is smaller than the d50 value of the platelet-shaped magnetic or magnetizable pigment particles (T<d50), it is preferred that the thickness T of the at least partially cured coating layer (x40) is smaller than d50*sin(α) (T<d50*(sin α)).

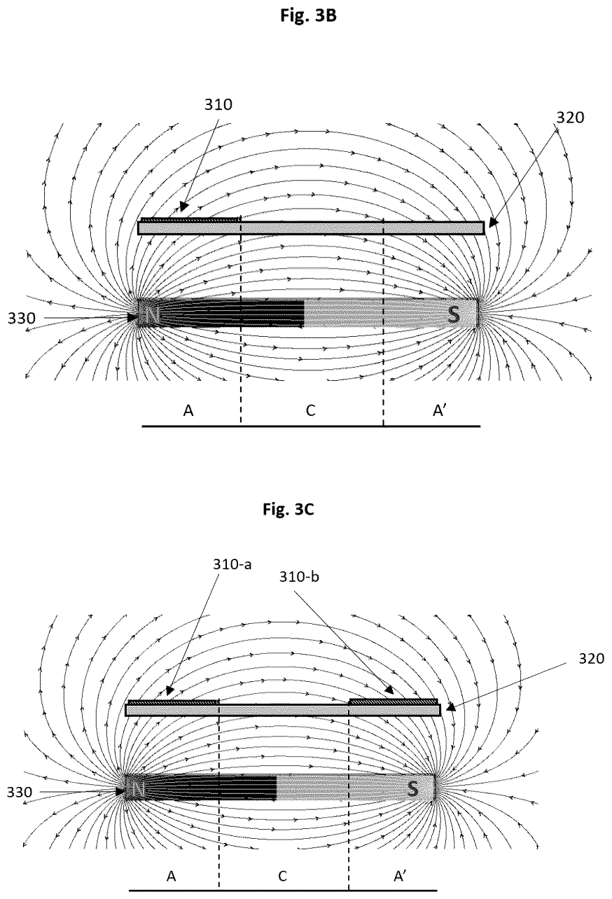

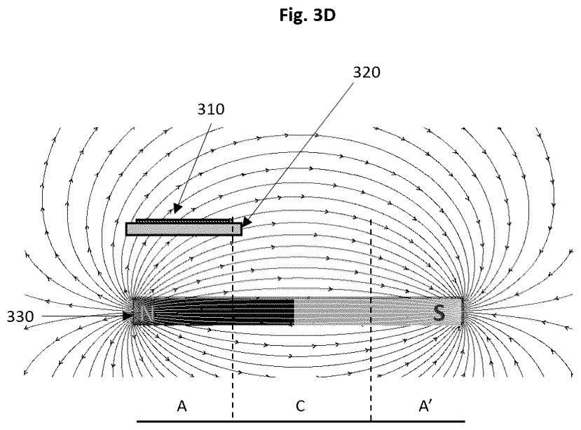

According to one embodiment, the orientation of the platelet-shaped magnetic or magnetizable pigment particles and the elevation angles γ of said particles in the at least partially cured coating layer (x40) are obtained by submitting the platelet-shaped magnetic or magnetizable pigment particles to the magnetic field of the magnetic-field generating device (x30) described herein in one or more areas (shown in FIG. 3A-D as areas A and A′) wherein the magnetic field is substantially inhomogeneous (i.e. a magnetic field which does not have a substantially constant magnitude and direction over the entire area(s) of interest (for mono-axial orientation); or a magnetic field which is not substantially confined to a plane (for bi-axial orientation), wherein the angle α is formed by the two-dimensional surface of the substrate (x20) at the positions of the particles and a tangent to magnetic field lines of the magnetic field within the one or more areas (A, A′, Aⁱ′), wherein said angle α is larger than or equal to 12° and smaller than or equal to 75° (12°≤|α|≤75°) or larger than or equal to 105° and smaller than or equal to 168° (105°≤|α|≤168°). Should the platelet-shaped magnetic or magnetizable pigment particles be submitted to the magnetic field of the magnetic-field generating device (x30) in more than one areas (for example two areas as shown in FIGS. 3A and 3C), two angles α and α′ are described, wherein the angle α′ is larger than or equal to 12° and smaller than or equal to 75° (12°≤|α|≤≤75°) or larger than or equal to 105° and smaller than or equal to 168° (105°≤|α′|≤168°), α′ being different from α, preferably α′ and α differing of at least 30°. According to one embodiment wherein the platelet-shaped magnetic or magnetizable pigment particles are exposed to the magnetic field of the magnetic-field generating device (x30) in more than one areas (for example two areas as shown in FIGS. 3A and 3C), the substrate (x20) carrying the coating layer (x10) is provided in said more than one areas with the angle α and α′, wherein, when angle α is larger than or equal to 12° and smaller than or equal to 75° (12°≤|α′|≤75° then angle α′ is larger than or equal to 105° and smaller than or equal to 168° (105°≤|α′|≤168°).

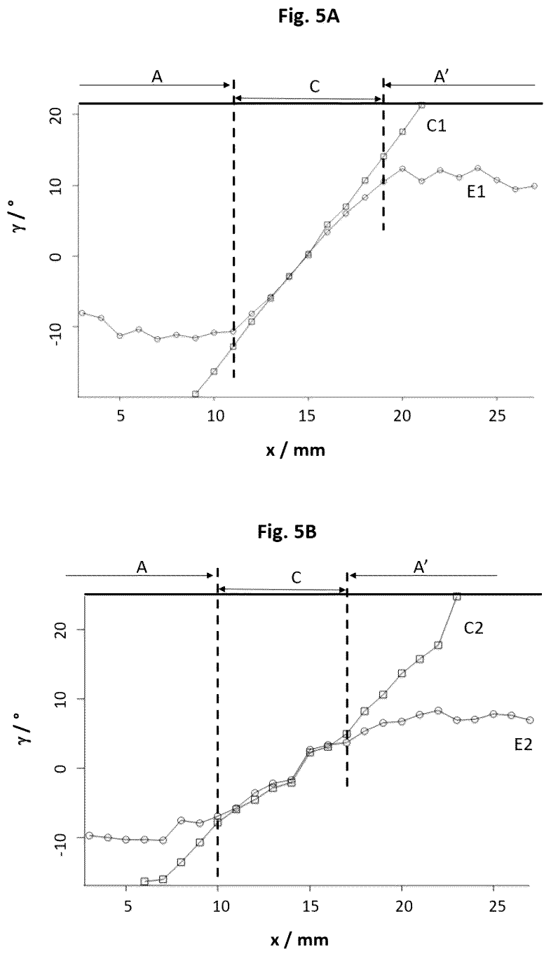

The OELs obtained by the exposure of the platelet-shaped magnetic or magnetizable pigment particles in the one or more areas wherein the magnetic field of the magnetic-field generating device (x30) is substantially inhomogeneous comprise said magnetically oriented platelet-shaped magnetic or magnetizable pigment particles experiencing different angles α described herein during the orientation step (i.e. the angle α in the area A being different from the angle α′ in the area A′), provided that that angles have a value within the range described herein. An example of a magnetic-field-generating device suitable for orienting the platelet-shaped magnetic or magnetizable pigment wherein the magnetic field is substantially inhomogeneous in one or more areas marked as A and A′ is a bar dipole magnet having its magnetic axis substantially parallel to the substrate (x20) surface as shown in FIG. 3 and is described hereafter. Other examples of a magnetic-field-generating device suitable for orienting the platelet-shaped magnetic or magnetizable pigment wherein the magnetic field is substantially inhomogeneous in one or more areas are disclosed in in FIGS. 5A-B, 9B-9E and 10A-B of in U.S. Pat. No. 7,047,883 as described hereafter. Advantageously, the present invention provides methods for producing OELS with a wide surface uniform pigment orientation even though the exposure step is carried out with an inhomogeneous magnetic field.

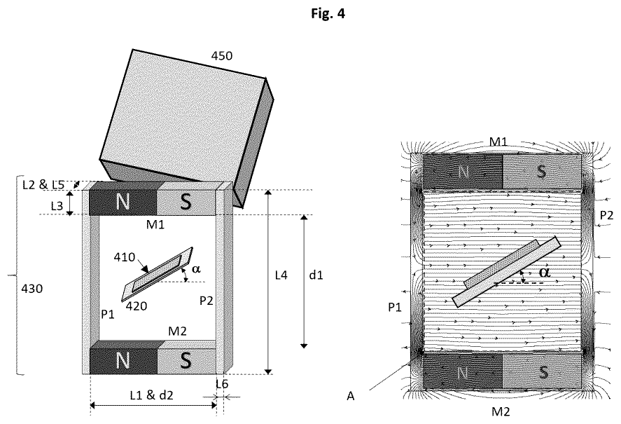

According to one embodiment, the orientation of the platelet-shaped magnetic or magnetizable pigment particles and the elevation angles γ of said particles in the at least partially cured coating layer (x40) are obtained by submitting the platelet-shaped magnetic or magnetizable pigment particles to the magnetic field of the magnetic-field generating device (x30) described herein in one or more areas (shown in FIG. 4 as area A) wherein the magnetic field is substantially homogeneous (i.e. a magnetic field which has a substantially constant magnitude and direction over the entire area(s) of interest (for mono-axial orientation); or a magnetic field which is substantially confined to a plane (for bi-axial orientation), wherein an angle α is formed by the two-dimensional surface of the substrate (x20) at the positions of the particles and a tangent to magnetic field lines of the magnetic field within the one or more areas (A, A′, Aⁱ′), wherein said angle α is larger than or equal to 12° and smaller than or equal to about 75° (12°≤|α|≤75°) or larger than or equal to about 105° and smaller than or equal to about 168° (105°≤|α|≤168°). The OELs obtained by the exposure of the platelet-shaped magnetic or magnetizable pigment particles in the one or more areas wherein the magnetic field of the magnetic-field generating device (x30) is substantially homogeneous comprise said magnetically oriented platelet-shaped magnetic or magnetizable pigment particles experiencing substantially the same angle α described herein during the orientation step.

The step b) described herein is carried out to so as to mono-axially or bi-axially orient at least a part of the platelet-shaped magnetic or magnetizable pigment particles described herein. In contrast to a mono-axial orientation wherein magnetic or magnetizable pigment particles are orientated in such a way that only their main axis is constrained by the magnetic field, carrying out a bi-axial orientation means that the platelet-shaped magnetic or magnetizable pigment particles are made to orientate in such a way that their two main axes X and Y are constrained. That is, each platelet-shaped magnetic or magnetizable pigment particle can be considered to have a major axis in the plane of the pigment particle and an orthogonal minor axis in the plane of the pigment particle. The axes Y and Y of the platelet-shaped magnetic or magnetizable pigment particles are each caused to orient according to the magnetic field. Effectively, this results in neighboring platelet-shaped magnetic pigment particles that are close to each other in space to be substantially parallel to each other. Put another way, a bi-axial orientation aligns the planes of the platelet-shaped magnetic or magnetizable pigment particles so that the planes of said pigment particles are oriented to be substantially parallel relative to the planes of neighboring (in all directions) platelet-shaped magnetic or magnetizable pigment particles.

According to one embodiment, the step b) is carried out to so as to mono-axially orient at least a part of the platelet-shaped magnetic or magnetizable pigment particles described herein. Suitable magnetic-field generating devices for mono-axially orienting the platelet-shaped magnetic or magnetizable pigment particles described herein are not limited.

According to one embodiment shown in FIG. 3A-D, a suitable magnetic-field generating device (330) for mono-axially orienting at least a part of the platelet-shaped magnetic or magnetizable pigment particles consists of a bar dipole magnet having its magnetic axis substantially parallel to the substrate (x20) surface. As shown in FIG. 3A-D, the platelet-shaped magnetic or magnetizable pigment particles in the coating layer (310) on the substrate (320) are exposed to the magnetic field (magnetic field lines shown as lines with arrows pointing from the North Pole to the South Pole) of the magnetic field of the magnetic-field generating device (330) described herein in one or more areas (shown as areas A and A′) wherein the magnetic field is substantially inhomogeneous and wherein the substrate (320) carrying the coating layer (310) is provided in said one or more areas with the angle α described herein.

According to one embodiment shown in FIG. 4 and used in the Examples hereafter, a suitable magnetic-field generating device (430) for mono-axially orienting at least a part of the platelet-shaped magnetic or magnetizable pigment particles consists of a rectangular assembly comprising two bar dipole magnets (M1, M2) and two pole pieces (P1, P2). The platelet-shaped magnetic or magnetizable pigment particles in the coating layer (410) on the substrate (420) are exposed to the magnetic field (magnetic field lines shown as lines with arrows pointing from the North Pole to the South Pole) of the magnetic-field generating device (430) in one or more areas (shown as a dotted rectangle A) wherein the magnetic field is substantially homogeneous and wherein the magnetic field lines are substantially parallel to each other in said area and wherein the substrate (420) carrying the coating layer (410) is provided in said one or more areas with the angle α described herein. The magnetic-field generating device (430) shown in FIG. 4 comprises two spaced apart bar dipole magnets (M1, M2) having a same magnetic direction and having a same length and two spaced apart pole pieces (P1, P2) having a same length arranged as a rectangular assembly, wherein M1 is not adjacent to and faces M2, P1 is not adjacent to and faces P2, and wherein P1 is placed at a distance corresponding to the length of M1/M2 from P2.

According to another embodiment, suitable magnetic-field generating devices (430) for mono-axially orienting at least a part of the platelet-shaped magnetic or magnetizable pigment particles as shown in FIGS. 5A-B, 9B-9E and 10A-10B of U.S. Pat. No. 7,047,883, wherein the platelet-shaped magnetic or magnetizable pigment particles in the coating layer on the substrate are exposed to the magnetic field of the magnetic-field generating devices in one or more areas wherein the magnetic field is substantially inhomogeneous and wherein the substrate carrying the coating layer (410) is provided in said one or more areas with the angle α described herein. In particular, the magnetic-field generating device shown in FIG. 5A-B U.S. Pat. No. 7,047,883 comprise two spaced apart magnets 84 placed on a magnetic base 62 with their North poles facing the substrate; the magnetic-field generating device shown in FIG. 9B U.S. Pat. No. 7,047,883 comprises a magnet 140 and the pigments articles are placed with an offset position relatively the magnet axes; the magnetic-field generating device shown in FIG. 9C U.S. Pat. No. 7,047,883 comprises two magnets 142, and one magnet 142′ having a diamond-shaped cross section, wherein the two magnets 142 have their North pole facing the substrate while the intervening magnet 142′ has its South pole facing the substrate; the magnetic-field generating device shown in FIG. 9D U.S. Pat. No. 7,047,883 comprises two magnets 144, and one magnet 144′ having roof-shaped, hexagonal, rounded, trapezoidal, or other cross-sections, wherein the two magnets 144 have their North pole facing the substrate while the intervening magnet 144′ has its South pole facing the substrate; and the magnetic-field generating device shown in FIG. 9E U.S. Pat. No. 7,047,883 comprises five magnets, the first magnet 142 being a diamond-shaped magnet with its North pole facing the substrate, the second magnet 146 being a rectangular magnet with its South pole facing the substrate, the third magnet 148 being a magnet with rounded top having its North pole facing the substrate, the fourth magnet 150 being a roof-shaped and having its South pole facing the substrate and the fifth magnet 152 being also a roof-shaped magnet and having its North pole facing the substrate.

According to another embodiment, the step b) is carried out so as to bi-axially orient at least a part of the platelet-shaped magnetic or magnetizable pigment particles. For embodiments wherein the method described herein comprises the step of exposing the coating layer (x10) to the magnetic field of the magnetic-field generating device (x30) described herein so as to bi-axially orient at least a part of the magnetic or magnetizable pigment particle, the coating layer (x10) may be exposed more than one time to said magnetic-field generating device. Suitable magnetic-field generating devices for bi-axially orienting the platelet-shaped magnetic or magnetizable pigment particles described herein are not limited. As known by the man skilled in the art, bi-axial orientation of platelet-shaped magnetic or magnetizable pigment particles requires a dynamic magnetic field (i.e. time-variable/time-dependent magnetic field) that changes its direction and/or its strength, forcing the particles to oscillate until both main axes, X-axis and Y-axis, become aligned. In other words, bi-axial orientation requires a non-concomitant movement of the coating layer (x10) comprising the platelet-shaped magnetic or magnetizable pigment particles with respect to the magnetic-field-generating device.

According to one embodiment shown in FIG. 10A-B of WO 2018/019594 A1, a suitable magnetic-field generating device (430) for bi-axially orienting at least a part of the platelet-shaped magnetic or magnetizable pigment particles consists of a linear arrangement of at least four, magnets (M1-M4) that are positioned in a staggered fashion or in zigzag formation, provided that the substrate carrying the coating layer is provided in one or more areas of the magnetic field of the device with the angle α values described herein. EP 2 157 141 A1 discloses a similar suitable magnetic-field generating device in FIG. 5, wherein the magnetic-field generating device may be used for bi-axially orienting at least a part of the platelet-shaped magnetic or magnetizable pigment particles and consists of a linear arrangement of at least three, preferably at least four, magnets that are positioned in a staggered fashion or in zigzag formation.

According to one embodiment shown in FIG. 8A-B of WO 2018/019594 A1, a suitable magnetic-field generating device (430) for bi-axially orienting at least a part of the platelet-shaped magnetic or magnetizable pigment particles consists of two dipole magnets (M1, M2) having an opposite magnetic direction, provided that the substrate carrying the coating layer is provided in one or more areas of the magnetic field of the device with the angle ox values described herein.

According to one embodiment shown in FIG. 7A-B of WO 2018/019594 A1, a suitable magnetic-field generating device (430) for bi-axially orienting at least a part of the platelet-shaped magnetic or magnetizable pigment particles consists of two dipole magnets (M1, M2) having a same magnetic direction, provided that the substrate carrying the coating layer is provided in one or more areas of the magnetic field of the device with the angle α values described herein.

According to one embodiment shown in FIG. 3A of WO 2018/019594 A1, a suitable magnetic-field generating device (430) for bi-axially orienting at least a part of the platelet-shaped magnetic or magnetizable pigment particles consists of a Halbach array comprising five dipole magnets (M1-M5), provided that the substrate carrying the coating layer is provided in one or more areas of the magnetic field of the device with the angle ox values described herein.

According to one embodiment shown in FIG. 12A of WO 2016/083259 A1, a suitable magnetic-field generating device for bi-axially orienting at least a part of the platelet-shaped magnetic or magnetizable pigment particles consists of a Halbach cylinder assembly comprising four structures, each one comprising a magnet bar (M1-M4) surrounded by a magnet-wire coil (not shown), provided that the substrate carrying the coating layer is provided in one or more areas of the magnetic field of the device with the angle α values described herein.

According to one embodiment shown FIG. 2A of the co-pending application EP 20176506.2, a suitable magnetic-field generating device (430) for bi-axially orienting at least a part of the platelet-shaped magnetic or magnetizable pigment particles consists of an assembly of eight bar dipole magnets (M1-M8), said assembly comprising a first set comprising a first bar dipole magnet (M4) and two second bar dipole magnets (M1, M6), a second set comprising a first bar dipole magnet (M5) and two second bar dipole magnets (M3; M8) and a first pair of third bar dipole magnets (M2, M7), provided that the substrate carrying the coating layer is provided in one or more areas of the magnetic field of the device with the angle α values described herein.

According to one embodiment shown in FIG. 5A1-3 of the co-pending application EP 20194060.8, a suitable magnetic-field generating device for bi-axially so as orient at least a part of the platelet-shaped magnetic or magnetizable pigment particles consists of an assembly comprising nine bar dipole magnets (M1-M5) with alternating North-South magnetic directions and arranged in a row, provided that the substrate carrying the coating layer is provided in one or more areas of the magnetic field of the device with the angle ox values described herein.

According to one embodiment, the step b) described herein consists of two magnetic orientation steps described in WO 2015/086257 A1, said steps consisting of i) exposing the coating layer (x10) comprising the platelet-shaped magnetic or magnetizable pigment particles to a dynamic magnetic field of a first magnetic-field-generating device such as those described hereabove or in WO 2015/086257 A1 so as to bi-axially orient at least a part of the platelet-shaped magnetic or magnetizable pigment particles and ii) exposing the coating layer (x10) to a static magnetic field of a second magnetic-field-generating device such as those described herein, thereby mono-axially re-orienting at least a part of the platelet-shaped magnetic or magnetizable pigment particles, provided that the substrate (x20) carrying the coating layer (x10) is provided in one or more areas of the second magnetic field of the second magnetic-field-generating device with the angle ox values described herein. Should these two steps i) and ii) be carried out, at least the second step ii) is used to orient the at least a part of the platelet-shaped magnetic or magnetizable pigment particles by providing the substrate (x20) carrying the coating layer (x10) in the one or more areas described herein with the angle α values described herein.

During the magnetic orientation described herein of the magnetic or magnetizable pigment particles, the substrate (x20) carrying the coating layer (x10) may be disposed on a non-magnetic supporting plate (x40) which is made of one or more non-magnetic materials.

The methods described herein further comprise, partially simultaneously with or subsequently to step b), the step c) of at least partially curing the coating layer (x10) with the curing unit (x50) described herein so as to fix the position and orientation of the platelet-shaped magnetic or magnetizable pigment particles in the coating layer (x10) so as to produce an at least partially cured coating layer (x40) having a thickness T. By “partially simultaneously”, it is meant that both steps are partly performed simultaneously, i.e. the times of performing each of the steps partially overlap. In the context described herein, when curing is performed partially simultaneously with the orientation step b), it must be understood that curing becomes effective after the orientation so that the pigment particles have the time to orient before the complete or partial curing or hardening of the OEL.

Should the step c) being carried out subsequently to the step b) described herein, the timing between said steps is preferably between about 0.1 second and about 1.5 seconds, more preferably between about 0.1 seconds and 0.5 seconds.

The methods described herein produce the OELs described herein, wherein neighboring magnetically oriented platelet-shaped magnetic or magnetizable pigment particles have at least their main axis X substantially parallel to each other in one or more regions (x40-a, x40-b) of the at least partially cured coating layer (x40).

Suitable curing units (x50) include equipments for UV-visible curing units comprising a high-power light-emitting-diode (LED) lamp, or an arc discharge lamp, such as a medium-pressure mercury arc (MPMA) or a metal-vapor arc lamp, as the source of the actinic radiation. The selective curing units described herein may comprise one or more fixed or removable photomasks including one or more voids corresponding to a pattern to be formed as a part of the coating layer. The one or more selective curing units may be addressable such as the scanning laser beam disclosed in EP 2 468 423 A1, an array of light-emitting diodes (LEDs) disclosed in WO 2017/021504 A1 or an actinic radiation LED source comprising an array of individually addressable actinic radiation emitters disclosed in WO 2020/148076A1.

FIG. 2A-2E disclose cross-sections of OELs described herein, wherein said OELs comprise one or more at least partially cured coating layers (240, 241) having a thickness (T, T′, etc.) and comprising magnetically oriented platelet-shaped magnetic or magnetizable pigment particles incorporated therein.

According to one embodiment shown for example in FIG. 2A, the OELs described herein comprise a single at least partially cured coating layer (210) having a thickness T with magnetically oriented platelet-shaped magnetic or magnetizable pigment particles incorporated therein, wherein substantially all the platelet-shaped magnetic or magnetizable pigment particles in the one or more regions have substantially the same elevation angle γ and wherein the pigment particles have a d50 value larger than T.

According to one embodiment shown for example in FIG. 2B, the OELs described herein independently comprise a single at least partially cured coating layer (240) having a thickness T and comprising platelet-shaped magnetic or magnetizable pigment particles in one or more first regions (240-a) and platelet-shaped magnetic or magnetizable pigment particles in one or more second regions (240-b), wherein substantially all the platelet-shaped magnetic or magnetizable pigment particles in the one or more first regions (240-a) have substantially the same elevation angle γ and substantially all the platelet-shaped magnetic or magnetizable pigment particles in the one or more second regions (240-b) have substantially the same additional elevation angle γ′, said elevation angle γ and additional elevation angle γ′ being different from each other and/or being not coplanar and wherein the particles have a d50 value larger than T.

According to one embodiment shown for example in FIG. 2C-F, the OELs described herein independently comprise an at least partially cured first coating layer (240) with magnetically oriented platelet-shaped magnetic or magnetizable pigment particles incorporated therein, wherein substantially all the platelet-shaped magnetic or magnetizable pigment particles have substantially the same elevation angle γ and further comprise an at least partially cured second coating layer (241) with a thickness T′ with magnetically oriented second platelet-shaped magnetic or magnetizable pigment particles incorporated therein, wherein substantially all the platelet-shaped magnetic or magnetizable pigment particles have substantially the same additional elevation angle γ′ said elevation angle γ and additional elevation angle γ′ being different from each other and/or being not coplanar and wherein the pigment particles in the at least partially cured coating layer (240) have a d50 value larger than T and the pigment particles in the at least partially cured second coating layer (241) have a d50 value larger than T′. The at least partially cured second coating layer (241) is either at least partially or fully overlapping the at least partially cured coating layer (240) (see FIGS. 2C and 2D), or the at least partially cured second coating layer (241) is adjacent to the at least partially cured coating layer (240) (see FIG. 2E), or the at least partially cured second coating layer (241) is spaced apart from the at least partially cured coating layer (x10) (see FIG. 2F).

FIG. 2C schematically illustrates a cross-section of an OEL comprising a at least partially cured first coating layer (240) having a thickness T and comprising magnetically oriented first platelet-shaped magnetic or magnetizable pigment particles incorporated therein and an at least partially cured second coating layer (241) having a thickness T′ with magnetically oriented second platelet-shaped magnetic or magnetizable pigment particles incorporated therein, said at least partially cured second coating layer (241) partially overlapping the at least partially cured first coating layer (240), wherein substantially all the first platelet-shaped magnetic or magnetizable pigment particles in the at least partially cured coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second pigment particles in the at least partially cured second coating layer (241) have a d50 value larger than T′.

FIG. 2D schematically illustrates a cross-section of an OEL comprising an at least partially cured first coating layer (240) having a thickness T with magnetically oriented first platelet-shaped magnetic or magnetizable pigment particles incorporated therein and a at least partially cured second coating layer (241) having a thickness T′ with magnetically oriented second platelet-shaped magnetic or magnetizable pigment particles incorporated therein, said at least partially cured second coating layer (241) fully overlapping the at least partially cured first coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2E schematically illustrates a cross-section of an OEL comprising an at least partially cured first coating layer (240) having a thickness T with magnetically oriented first platelet-shaped magnetic or magnetizable pigment particles incorporated therein and a at least partially cured second coating layer (241) having a thickness T′ with magnetically oriented second platelet-shaped magnetic or magnetizable pigment particles incorporated therein, said at least partially cured second coating layer (241) being adjacent to the at least partially cured coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2F schematically illustrates a cross-section of an OEL comprising an at least partially cured first coating layer (240) having a thickness T with magnetically oriented first platelet-shaped magnetic or magnetizable pigment particles incorporated therein and a at least partially cured second coating layer (241) having a thickness T′ with magnetically oriented second platelet-shaped magnetic or magnetizable pigment particles incorporated therein, said at least partially cured second coating layer (241) being spaced apart from the at least partially cured coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2G schematically illustrates a cross-section of an OEL comprising an at least partially cured first coating layer (240) having a thickness T with magnetically oriented first platelet-shaped magnetic or magnetizable pigment particles incorporated therein and a at least partially cured second coating layer (241) having a thickness T′ with magnetically oriented second platelet-shaped magnetic or magnetizable pigment particles incorporated therein, said at least partially cured second coating layer (241) partially overlapping the at least partially cured coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle γ and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

FIG. 2H schematically illustrates a cross-section of an OEL comprising an at least partially cured first coating layer (240) having a thickness T with magnetically oriented first platelet-shaped magnetic or magnetizable pigment particles incorporated therein and a at least partially cured second coating layer (241) having a thickness T′ with magnetically oriented second platelet-shaped magnetic or magnetizable pigment particles incorporated therein, said at least partially cured second coating layer (241) fully overlapping the at least partially cured coating layer (240), wherein substantially all the first platelet-shaped magnetic or magnetizable pigment particles in the at least partially cured first coating layer (240) have substantially the same elevation angle γ and substantially all the second platelet-shaped magnetic or magnetizable pigment particles in the at least partially cured second coating layer (241) have substantially the same additional elevation angle γ′, said elevation angle Y and additional elevation angle γ′ being different from each other and/or being not coplanar and wherein the first particles in the at least partially cured first coating layer (240) have a d50 value larger than T and the second particles in the at least partially cured second coating layer (241) have a d50 value larger than T′.

According to one embodiment, the method described herein for producing the one or more OELs described herein made of a single at least partially cured coating layer (x40) (see for example FIG. 2A) comprises the steps of
a) applying on the substrate (x20) surface described herein the radiation curable coating composition comprising the platelet-shaped magnetic or magnetizable pigment particles described herein, said radiation curable coating composition being in a first, liquid state so as to form a coating layer (x10),
b) exposing the coating layer (x10) to the magnetic field of the magnetic-field generating device (x30) described herein with the substrate (x20) carrying the coating layer (x10) described herein being provided in the one or more areas (A, A′, Aⁱ″) described herein and with the angle xx being larger than or equal to 12° and smaller than or equal to about 75° (12°≤|α|≤75°) or larger than or equal to 105° and smaller than or equal to 168° (105°≤|α|≤168°) described herein, partially simultaneously with or subsequently to the step b), the step c) of at least partially curing the coating layer (x10) with the curing unit (x50) to fix at least a part of the platelet-shaped magnetic or magnetizable particles in their adopted positions and orientations so as to produce the single at least partially cured coating layer (x40) having a thickness T, said thickness T being smaller than the d50 value of the platelet-shaped magnetic or magnetizable pigment particles.

According to another embodiment, the method described herein for producing the one or more OELs described herein independently made of a single at least partially cured coating layer (x40) and comprising magnetically oriented platelet-shaped magnetic or magnetizable pigment particles in said single at least partially cured coating layer (x40), said single at least partially cured coating layer (x40) comprising one or more first regions (x40-a) and one or more second regions (x40-b) (see for example FIG. 2B), comprises the steps of
a) applying on the substrate (x20) surface described herein the radiation curable coating composition comprising the platelet-shaped magnetic or magnetizable pigment particles described herein said radiation curable coating composition being in a first, liquid state so as to form a coating layer (x10) comprising one or more first regions (x10-a) and one or more second regions (x10-b),
b) exposing the coating layer (x10) to the magnetic field of the magnetic-field generating device (x30-a) described herein with the substrate (x20) carrying the coating layer (x10) described herein being provided in the one or more areas (A, A′, Aⁱ′) described herein and with the angle ox being larger than or equal to 12° and smaller than or equal to about 75° (12°≤|α|≤75°) or larger than or equal to 105° and smaller than or equal to 168° (105°≤|α|≤168°) described herein, partially simultaneously with or subsequently to the step b), the step c) of at least partially selectively curing the one or more first regions (x10a) of the single coating layer (x10) with the curing unit (x50) to fix at least a part of the platelet-shaped magnetic or magnetizable particles in their adopted positions and orientations,
d) exposing the single coating layer (x10) to the magnetic field of a second magnetic field generating device (x30-b) so as to orient at least a part of the platelet-shaped magnetic or magnetizable pigment particles in the one or more second regions (x10b), wherein the substrate (x20) is provided in said one or more areas (A, A′, Aⁱ′) and wherein an angle ox′ formed by the two-dimensional surface of the substrate (x20) at the positions of the platelet-shaped magnetic or magnetizable pigment particles and a tangent to magnetic field lines of the second magnetic field within the one or more areas (A, A′, Aⁱ′) is larger than or equal to 12° and smaller than or equal to 75° (12°≤|α′|≤75°) or larger than or equal to 105° and smaller than or equal to 168° (105°≤|α′|≤168°), wherein the second magnetic-field generating device (x30-b) is the same or is different from the magnetic-field generating device (x30-a) of step b), a′ being different from a, preferably α′ and α differing of at least 30°; and
partially simultaneously with or subsequently to the step d), the step e) of at least partially curing the single coating layer (x10) with the curing unit (x50) described herein so as to form the single at least partially cured coating layer (x40), wherein
neighboring magnetically oriented platelet-shaped magnetic or magnetizable pigment particles have at least their main axis X substantially parallel to each other in the one or more first regions (x40-a) of the single at least partially cured coating layer (x40), and
neighboring magnetically oriented platelet-shaped magnetic or magnetizable pigment particles have at least their main axis X substantially parallel to each in the one or more second region (x40-b) of the single at least partially cured coating layer (x40).

According to another embodiment, the method described herein for producing the one or more OELs described herein and comprising magnetically oriented first platelet-shaped magnetic or magnetizable pigment particles in an at least partially cured first coating layer (x40) and comprising magnetically oriented second platelet-shaped magnetic or magnetizable pigment particles in an at least partially cured second coating layer (x41), wherein the at least partially cured second coating layer (x41) is either at least partially or fully overlapping the at least partially cured first coating layer (x40) (see for example FIGS. 2C-D and FIGS. 2G-H) comprises the steps of:
a) applying on the substrate (x20) surface described herein a first radiation curable coating composition comprising first platelet-shaped magnetic or magnetizable pigment particles described herein said first radiation curable coating composition being in a first, liquid state so as to form a first coating layer (x10);
b) exposing the coating layer (x10) to the magnetic field of the magnetic-field generating device (x30-a) described herein with the substrate (x20) carrying the first coating layer (x10) described herein being provided in the one or more areas (A, A′, Aⁱ′) described herein and with the angle α being larger than or equal to 12° and smaller than or equal to about 75° (12°≤|α|≤75°) or larger than or equal to 105° and smaller than or equal to 168° (105°≤|α|≤168°) described herein, partially simultaneously with or subsequently to the step b), the step c) of at least partially curing the first coating layer (x10) with a curing unit (x50) to fix at least a part of the first platelet-shaped magnetic or magnetizable particles in their adopted positions and orientations so as to form the at least partially cured first coating layer (x40),
subsequently to step c), a step d) of applying either partially (FIG. 2C or FIG. 2G) or fully (FIG. 2D or FIG. 2H) on the at least partially cured first coating layer (x40) a second radiation curable coating composition comprising the second platelet-shaped magnetic or magnetizable pigment particles, said second radiation curable coating composition being in a first, liquid state so as to form a second coating layer (x11), wherein said second radiation curable coating composition is the same as or is different from the radiation curable coating composition of step a);
a step e) of exposing the second coating layer (x11) to a second magnetic field of a second magnetic-field generating device (x30-b) in one or more areas (A, A′, Aⁱ′) of said second magnetic field so as to orient at least a part of the second platelet-shaped magnetic or magnetizable pigment particles, wherein the substrate (x20) carrying the second coating layer (x41) is provided in said one or more areas (A, A′, Aⁱ′) and wherein an angle α′ formed by the two-dimensional surface of the substrate (x20) at the positions of the second platelet-shaped magnetic or magnetizable pigment particles and a tangent to magnetic field lines of the second magnetic field within the one or more areas (A, A′, Aⁱ′) is larger than or equal to 12° and smaller than or equal to 75° (12°≤|x′|≤75°) or larger than or equal to 105° and smaller than or equal to 168° (105°≤|α′|≤168°), wherein the second magnetic-field generating device (x30-b) is the same or is different from the magnetic-field generating device of step b), α′ being different from α, preferably α′ and α differing of at least 30°; and
f) partially simultaneously with or subsequently to the step e) of exposing the second coating layer (x11) to the second magnetic field, a step of at least partially curing the second coating layer (x11) with the curing unit (x50) so as to at least partially fix the position and orientation of the second platelet-shaped magnetic or magnetizable pigment particles in the second coating layer (x11) so as to form the at least partially cured second coating layer (x41),
wherein neighboring magnetically oriented first platelet-shaped magnetic or magnetizable pigment particles have at least their main axis X substantially parallel to each other in the at least partially cured first coating layer (x40) and neighboring magnetically oriented second platelet-shaped magnetic or magnetizable pigment particles have at least their main axis X substantially parallel to each wherein neighboring magnetically oriented platelet-shaped magnetic or magnetizable pigment particles have at least their main axis X substantially parallel to each other in the at least partially cured second coating layer (x41), the magnetically oriented first platelet-shaped magnetic or magnetizable pigment particles in the at least partially cured coating layer (x40) having a different elevation angle than the magnetically oriented second platelet-shaped magnetic or magnetizable pigment particles in the at least partially cured second coating layer (x41).

According to another embodiment, the method described herein for producing the one or more OELs described herein and comprising the magnetically oriented first platelet-shaped magnetic or magnetizable pigment particles in an at least partially cured first coating layer (x40) and comprising magnetically oriented second platelet-shaped magnetic or magnetizable pigment particles in an at least partially cured second coating layer (x41), wherein the at least partially cured second coating layer (x41) is adjacent to the at least partially cured first coating layer (x40) (see for example FIG. 2E) or the at least partially cured second coating layer (x41) is spaced apart from the at least partially cured first coating layer (x40) (FIG. 2F) comprises the steps of
a) applying on the substrate (x20) surface described herein a first radiation curable coating composition comprising first platelet-shaped magnetic or magnetizable pigment particles described herein said radiation curable coating composition being in a first, liquid state so as to form a first coating layer (x10),
b) exposing the first coating layer (x10) to the magnetic field of the magnetic-field generating device (x30) described herein with the substrate (x20) carrying the first coating layer (x10) described herein being provided in the one or more areas (A, A′, Aⁱ′) described herein and with the angle α being larger than or equal to 12° and smaller than or equal to about 75° (12°≤|α|≤75°) or larger than or equal to 105° and smaller than or equal to 168° (105°≤|α|≤168°) described herein, partially simultaneously with or subsequently to the step b), the step c) of at least partially curing the first coating layer (x10) with the curing unit (x50) to fix at least a part of the first platelet-shaped magnetic or magnetizable particles in their adopted positions and orientations so as to form the at least partially cured first coating layer (x40),
subsequently to step c), a step d) of applying a second radiation curable coating composition comprising second platelet-shaped magnetic or magnetizable pigment particles, said second radiation curable coating composition being in a first, liquid state so as to form a second coating layer (x11), wherein said second coating layer (x11) is either adjacent to (FIG. 2E) or spaced apart (FIG. 2F) from the coating layer (x40) and wherein said second radiation curable coating composition is the same as or is different from the radiation curable coating composition of step a);
a step e) of exposing the second coating layer (x11) to a second magnetic field of a second magnetic-field generating device in one or more areas (A, A′, Aⁱ′) of said second magnetic field so as to orient at least a part of the second platelet-shaped magnetic or magnetizable pigment particles, wherein the substrate (x20) carrying the second coating layer (x41) is provided in said one or more areas (A, A′, Aⁱ′) and wherein an angle αx′ formed by the two-dimensional surface of the substrate (x20) at the positions of the second platelet-shaped magnetic or magnetizable pigment particles and a tangent to magnetic field lines of the second magnetic field within the one or more areas (A, A′, Aⁱ′) is larger than or equal to 12° and smaller than or equal to 75° (12°≤|α′|≤75°) or larger than or equal to about 105° and smaller than or equal to 168° (105°≤|α′|≤168°), wherein the second magnetic-field generating device (x30-b) is the same or is different from the magnetic-field generating device of step b), α′ being different from α, preferably α′ and α differing of at least 30°; and
f) partially simultaneously with or subsequently to the step e) of exposing the second coating layer (x11) to the second magnetic field, a step of at least partially curing the second coating layer (x11) with the curing unit (x50) so as to at least partially fix the position and orientation of the second platelet-shaped magnetic or magnetizable pigment particles in the second coating layer (x11) so as to form the at least partially cured second coating layer (x41),
wherein neighboring magnetically oriented first platelet-shaped magnetic or magnetizable pigment particles have at least their main axis X substantially parallel to each other in the at least partially cured first coating layer (x40) and neighboring magnetically oriented second platelet-shaped magnetic or magnetizable pigment particles have at least their main axis X substantially parallel to each in the at least partially cured second coating layer (x41), the magnetically oriented particles in the at least partially cured coating layer (x40) having a different elevation angle than the magnetically oriented platelet-shaped magnetic or magnetizable pigment particles in the at least partially cured second coating layer (x41).

The OELs described therein comprise the magnetically oriented platelet-shaped magnetic or magnetizable pigment particles described herein in the at least partially cured coating layer (x40) and in the at least partially cured second coating layer (x41), as the case may be, wherein the thickness T of the at least partially cured coating layer (x40) (see for example FIG. 2A-E) is smaller than the d50 value of the platelet-shaped magnetic or magnetizable pigment particles and wherein the thickness T′ of the at least partially cured second coating layer (x41) (see for example FIG. 2C-E) is smaller than the d50 value of the platelet-shaped magnetic or magnetizable pigment particle. Typically, the platelet-shaped magnetic or magnetizable pigment particles described herein have a size d50 between about 5 μm and about 30 μm (as measured by direct optical granulometry) and the at least partially cured coating layer (x40) has a thickness between about 3 μm and about 30 μm (in particular a thickness between about 6 μm and about 30 μm for layers applied by screen printing, a thickness between about 3 μm and about 20 μm for layers applied by rotogravure printing and a thickness between about 3 μm and about 20 μm for layers applied by flexography printing), provided that said thickness is smaller than the d50 value of the platelet-shaped magnetic or magnetizable pigment particles. The thickness (T, T′, etc.) of the at least partially cured coating layer (x40, x41, etc.) directly impacts the elevation angle γ of the platelet-shaped magnetic or magnetizable pigment particles during the exposure to the magnetic field of a magnetic-field generating device by forcing the particles to adopt a maximal elevation angle γ as a result of the said thickness and the d50 value of the particles. This advantageously allow to freely chose the magnetic-field generating device irrespective of their magnetic field homogeneity/inhomogeneity to produce the OELs as described hereabove.

As described herein, the OELs comprises the magnetically oriented platelet-shaped magnetic or magnetizable pigment particles in at least partially cured coating layers on substrate. The substrate (x20) described herein is preferably selected from the group consisting of papers or other fibrous materials (including woven and non-woven fibrous materials), such as cellulose, paper-containing materials, glasses, metals, ceramics, plastics and polymers, metallized plastics or polymers, composite materials and mixtures or combinations of two or more thereof. Typical paper, paper-like or other fibrous materials are made from a variety of fibers including without limitation abaca, cotton, linen, wood pulp, and blends thereof. As is well known to those skilled in the art, cotton and cotton/linen blends are preferred for banknotes, while wood pulp is commonly used in non-banknote security documents. According to another embodiment, the substrate (x20) described herein is based on plastics and polymers, metallized plastics or polymers, composite materials and mixtures or combinations of two or more thereof. Suitable examples of plastics and polymers include polyolefins such as polyethylene (PE) and polypropylene (PP) including biaxially oriented polypropylene (BOPP), polyamides, polyesters such as poly(ethylene terephthalate) (PET), poly(1,4-butylene terephthalate) (PBT), poly(ethylene 2,6-naphthoate) (PEN) and polyvinylchlorides (PVC). Spunbond olefin fibers such as those sold under the trademark Tyvek® may also be used as substrate. Typical examples of metalized plastics or polymers include the plastic or polymer materials described hereabove having a metal disposed continuously or discontinuously on their surface. Typical examples of metals include without limitation aluminum (Al), chromium (Cr), copper (Cu), gold (Au), silver (Ag), alloys thereof and combinations of two or more of the aforementioned metals. The metallization of the plastic or polymer materials described hereabove may be done by an electrodeposition process, a high-vacuum coating process or by a sputtering process. Typical examples of composite materials include without limitation multilayer structures or laminates of paper and at least one plastic or polymer material such as those described hereabove as well as plastic and/or polymer fibers incorporated in a paper-like or fibrous material such as those described hereabove. Of course, the substrate can comprise further additives that are known to the skilled person, such as fillers, sizing agents, whiteners, processing aids, reinforcing or wet strengthening agents, etc. When the OELs described herein are used for decorative or cosmetic purposes including for example fingernail lacquers, said OEL may be produced on other type of substrates including nails, artificial nails or other parts of an animal or human being. The substrates (X20) described herein may be in the form of webs, sheets, thread reels, film reels, labels of the roll or label stocks.

Should the one or more OELs described herein be on a security document, and with the aim of further increasing the security level and the resistance against counterfeiting and illegal reproduction of said security document, the substrate may comprise printed, coated, or laser-marked or laser-perforated indicia, watermarks, security threads, fibers, planchettes, luminescent compounds, windows, foils, decals and combinations of two or more thereof. With the same aim of further increasing the security level and the resistance against counterfeiting and illegal reproduction of security documents, the substrate may comprise one or more marker substances or taggants and/or machine-readable substances (e.g. luminescent substances, UV/visible/IR absorbing substances, magnetic substances and combinations thereof).

According to one embodiment, the security documents and decorative articles comprising the substrate (x20) and the one or more OELs described herein further comprise one or more primer layers, wherein said one or more primer layers are present between the substrate (x20) and the one or more OELs. This may enhance the quality of the one or more OELs described herein or promote adhesion. Examples of such primer layers may be found in WO 2010/058026 A2. According to one embodiment, the one or more OELs described herein may further comprise one or more printed indicia being present between the substrate (x20) and the at least partially cured coating layer (x40) (or in other words, the one or more OELs at least partially overlap the one or more indicia). Preferably, each of the one or more OELs described herein and the one or more indicia described herein independently have the shape of an indicium. As used herein, the term “indicium” and “indicia” shall mean continuous and discontinuous layer(s) consisting of distinguishing markings or signs or patterns. Preferably, the indicia described herein are selected from the group consisting of codes, symbols, alphanumeric symbols, motifs, geometric patterns (e.g. circles, triangles and regular or irregular polygons), letters, words, numbers, logos, drawings, portraits and combinations thereof. Examples of codes include encoded marks such as an encoded alphanumeric data, a one-dimensional barcode, a two-dimensional barcode, a QR-code, datamatrix and IR-reading codes. The one or more indicia described herein may be solids indicia and/or raster indicia.

The present invention provides methods for producing the one or more OELs described herein and the one or more printed indicia being present between the substrate (x20) and the at least partially cured coating layer (x40), said methods comprising a step of applying a composition in the form of the one or more indicia described herein, said step occurring prior to the step a) described herein and further comprising a step of at least partially curing or hardening said composition. The step of applying the composition in the form of the one or more indicia described herein may be carried out by a contactless fluid microdispensing process such as curtain coating, spray coating, aerosol jet printing, electrohydrodynamic printing and inkjet printing or may be carried out by a printing process selected from the group consisting of offset, screen printing, rotogravure printing, flexography printing, intaglio printing (also referred in the art as engraved copper plate printing, engraved steel die printing). The present invention provides methods for producing the one or more OELs described herein and the one or more printed indicia being present between the substrate (x20) and the at least partially cured coating layer (x40) as well as between the substrate (x20) and the at least partially cured second coating layer (x41) for OELs comprising two at least partially cured coating layer (x40, x41) shown for example in FIG. 2E, said methods comprising a step of applying a composition in the form of the one or more indicia described herein, said step occurring prior to the step a) described herein and further comprising a step of at least partially curing or hardening said composition.

With the aim of increasing the durability through soiling or chemical resistance and cleanliness and thus the circulation lifetime of the security documents or decorative articles comprising the one or more OELs described herein, or with the aim of modifying their aesthetical appearance (e.g. optical gloss), one or more protective layers may be applied on top of the one or more OELs. When present, the one or more protective layers are typically made of protective varnishes. Protective varnishes may be radiation curable compositions, thermal drying compositions or any combination thereof. Preferably, the one or more protective layers are radiation curable compositions, more preferable UV-Vis curable compositions. The protective layers are typically applied after the formation of the OEL.

The OELs described herein may be provided directly on the substrate (x20) on which it shall remain permanently (such as for banknote applications or labels applications). Alternatively, the OELs may also be provided on a temporary substrate for production purposes, from which the OELs are subsequently removed.

Alternatively, one or more adhesive layers may be present on the one or more OELs or may be present on the substrate (x20), said one or more adhesive layers being on the side of the substrate opposite to the side where the one or more OELs are provided and/or on the same side as the one or more OELs and on top of the one or more OELs. Therefore, one or more adhesive layers may be applied to the one or more OELs or to the substrate, said one or more adhesive layers being applied after the curing step has been completed. Such an object may be attached to all kinds of documents or other articles or items without printing or other processes involving machinery and rather high effort. Alternatively, the substrate described herein comprising the one or more OELs described herein may be in the form of a transfer foil, which can be applied to a document or to an article in a separate transfer step. For this purpose, the substrate is provided with a release coating, on which the one or more OELs are produced.

### EXAMPLES

The Examples and Comparative Examples have been carried out by using the UV-Vis curable flexography printing ink of the formula given in Table 1 and the first and second magnetic assemblies described herebelow.

TABLE 1

| Ingredients | | |
|---|---|---|
| Chlorinated polyester (Allnex) | 15 | wt-% |
| Trimethylolpropane triacrylate monomer (Allnex) | 64 | wt-% |
| Speedcure TPO-L (Lambson) | 3.5 | wt-% |
| Genocure ® ITX (Rahn) | 2.5 | wt-% |
| magnetic pigment particles (*) | 15.0 | wt-% |
| viscosity(**) | 300 | mPas |

(*) 5-layer platelet-shaped magnetic pigment particles exhibiting a metallic silver color having a flake shape of diameter d₅₀ about 20 μm and thickness about 1 μm, obtained from VIAVI Solutions, Santa Rosa, CA.
(**)the viscosity of the UV-Vis curable flexography printing ink was at 25° C. on a Brookfield viscometer (model “DV-I Prime”, spindle S21 at 100 rpm).

For each sample, the following method was used to prepare examples E1-E3 and comparative examples C1-C3:
a) the UV-Vis curable ink provided in Table 1 was applied on the substrate (x20) as described hereabove so as to form a coating layer (x10),
b) the coating layer (x10) was exposed to the magnetic field of the magnetic-field generating device (x30) described hereabove in one or two areas (shown as A/A′ in FIGS. 3A and 4) so as to orient at least a part of the platelet-shaped magnetic or magnetizable pigment particles, and
c) partially simultaneously with or subsequently to (see Table 2) the exposure to the magnetic field, the coating layer (x10) was cured thus forming optical effect layer (OEL) (x40) comprising magnetically oriented platelet-shaped magnetic or magnetizable pigment particles having elevation angles γ provided in Table 2.

FIG. 3A and FIG. 4 schematically illustrate different examples of a substrate (x20) carrying a coating layer (x10) comprising pigment particles being exposed to the magnetic field of the magnetic-field generating device (x30) in one or more areas in one or more areas (shown as A, A′) of said magnetic field wherein the magnetic field is either inhomogeneous magnetic field (FIG. 3A) or substantially homogeneous (see FIG. 4) and wherein the angle α formed by the two-dimensional surface of the substrate (x20) at the positions of the particles and a tangent to magnetic field lines of the magnetic field within the two areas A and A′ of FIG. 3A or the one area A of FIG. 4 is larger than or equal to 12° and smaller than or equal to 75° (12°≤|α|≤75°) or larger than or equal to about 105° and smaller than or equal to 168° (105°≤|α|≤168°).

TABLE 2

| | thickness T | | | Elevation |
|---|---|---|---|---|
| | of the cured | Device | | angle γ |
| | coating layer | x30 | | (variation |
| | (x40) [μm] | shown in | Curing step c) | or value) |
| E1 | 8 | FIG. 3A | Partially simultaneously | FIG. 5A |
| | | | with step b) | |
| C1 | 24 | FIG. 3A | Partially simultaneously | FIG. 5A |
| | | | with step b) | |
| E2 | 8 | FIG. 3A | Subsequently to with step b) | FIG. 5B |
| C2 | 24 | FIG. 3A | Subsequently to with step b) | FIG. 5B |
| E3 | 8 | FIG. 4 | Partially simultaneously | 14° ± 1° |
| | | | with step b) | |
| C3 | 24 | FIG. 4 | Partially simultaneously | 28° ± 1° |
| | | | with step b) | |

The variation of the elevation angle γ of the pigment particles in the at least partially cured layer (x40) is shown in FIGS. 5A and 5B, wherein the x-axis (in mm) corresponds to the distance from the edge of the at least partially cured layer (x40), the value of 15 mm corresponding to the center of the magnetic field generating device shown in FIG. 3A and the center of the at least partially cured layer (x40). The corresponding y angles at 0 mm to 2 mm and 28 mm to 30 mm could not be not measured by conoscopic scatterometry as seen in the Examples shown in FIG. 5A-B.

For the magnetic field generating device illustrated in FIG. 3A, the angles α formed by the two-dimensional surface of the substrate (x20) at the positions of the particles and a tangent to magnetic field lines of the magnetic field within the one or more areas have been calculated with the software Vizimag 3.19 and are provided in Table 3.

TABLE 3

| | distance from the edge of the at | calculated |
|---|---|---|
| E1-E2 | least partially cured layer (x40)/mm | angle α |
| A | 3 | 54.6° |
| | 5 | 41.6° |
| | 10 | 17.4° |
| | 11* | 13.6 |
| C | 12 | 10° |
| | 13 | 6° |
| | 17 | 174° |
| | 18 | 170.0° |
| A′ | 19* | 166.5° |
| | 20 | 162.7° |
| | 25 | 140.3° |
| | 27 | 130.0° |

*last point before inflection, i.e. last point of area A, A′, respectively

### Step a)

The UV-Vis curable ink described in Table 1 was applied onto on a piece of PET (BG71 Colour Laser Printer & Copier OHP Film from Folex 100 micrometers thick, 45 mm×30 mm) (x20) so as to form the coating layer (45 mm×30 mm) (x10), wherein said application step was carried out with a semi-automatic laboratory coater (K101 Control Coater, RK Print) using a coating bar Nr 4 (nominal coating layer thickness of 36 μm; measured coating layer thickness of the cured coating layer 24 μm) for C1-C3, or a coating bar Nr 2 (nominal coating layer thickness of 12 μm; measured coating layer thickness of cured coating layer 8 μm) for E1-E3.

The inks used for examples E1-E3 and comparative examples C1-C3 had a viscosity that render them suitable for flexography printing and thus the application method used therein mimicked a flexography process.

### Step b)

Magnetic-Field-Generating Device for Orientation within an Inhomogeneous Magnetic Field (FIG. 3A)

The magnetic field generating device (330) shown in FIG. 3A (not shown true to scale for the clarity of the drawing) was used to orient the pigment particles. The magnetic field generating device (330) was a bar dipole magnet (M1) made of NdFeB N42 and having the following dimensions: 30 mm (L1)×30 mm (L2)×6 mm (L3). The distance between the surface of the magnetic field generating device (330) facing the substrate (320) and the coating layer (310) was 6 mm.

Magnetic-Field-Generating Device for Orientation within an Homogeneous Magnetic Field (FIG. 4)

The magnetic field generating device (430) shown in FIG. 4 (not shown true to scale for the clarity of the drawing) was used to orient the pigment particles. The magnetic field generating device (430) comprised two bar dipole magnets (M1, M2) and two pole pieces (P1, P2).

Each of the two bar dipole magnets (M1, M2) was made of NdFeB N42 and had the following dimensions: 40 mm (L1)×40 mm (L2)×10 mm (L3).

The two bar dipole magnets (M1, M2) were placed at a distance (d1) of about 40 mm from each other. The magnetic axis of each of the two bar dipole magnets (M1, M2) was substantially parallel to the length (L1) of said magnets, the magnetic direction of said two bar dipole magnets (M1, M2) pointing in the same direction.

Each of the two pole pieces (P1, P2) had the following dimensions: 60 mm (L4)×40 mm (L5)×3 mm (L6). The two pole pieces (P1, P2) were made of iron (ARMCO®).

The two bar dipole magnets (M1, M2) and the two pole pieces (P1, P2) were disposed such as to form a rectangular cuboid with a centered rectangular cuboid void, said void consisting of the area A wherein the magnetic field was substantially homogeneous and wherein the magnetic field lines were substantially parallel to each other, such that the distance (d2) between the two pole pieces (P1, P2) was about 40 mm, i.e. the distance (d2) between the two pole pieces (P1, P2) was the length (L1) of the two bar dipole magnets (M1, M2) and the distance between the two bar dipole magnets (M1, M2) was 40 mm

The substrate (420) and the coating layer (410) was disposed in the center of the void of the magnetic-magnetic field generating device (430) as illustrated in FIG. 4 while adopting an angle α, the angle α formed by the two-dimensional surface of the substrate (420) at the positions of the particles and a tangent to magnetic field lines of the magnetic field within the area A wherein the magnetic field was homogeneous, having a value of about 30°.

### Step c)

Partially simultaneously with or subsequently to (see Table 2) the exposure to the magnetic field of the magnetic-field generating device (x30), the coating layer (x10) was cured upon exposure during about 0.5 second to a UV-LED-lamp from Phoseon (Type FireFlex 50×75 mm, 395 nm, 8 W/cm²) thus forming optical effect layers (OEL) comprising magnetically oriented platelet-shaped magnetic or magnetizable pigment particles having elevation angles γ provided in Table 2.

For the example E2 and the comparative example C2, the UV-LED-lamp was disposed at a distance of 10 cm from the edge of the magnetic field generating device (330), that is the substrate (320) was moved away from the magnetic field generating device (330) to be exposed to the UV-LED-Lamp, the distance between the UV-LED-lamp and the coating layer (320) being about 1 cm, and the exposure time being about 0.5 second.

For the example E3 and comparative example C3, after about 1 second, the coating layer (610) was at least partially cured by a curing unit (450) (UV LED lamp (FireFly 395 nm, 4W/cm², from Phoseon) as illustrated in FIG. 4.

### Elevation Angles Measurements by Conoscopic Scatterometry

The conoscopic scatterometer measurements have been performed by using a conoscopic scatterometer as described in WO 2019/038371 A1, FIG. 4A (obtained from Eckhartd Optics LLC, 5430 Jefferson Ct, White Bear Lake, MN 55110; http://eckop.com). The elevation angles γ were measured on a coating layer surface of about 1 mm², i.e. the reported values were averaged on about one thousand pigment particles. The measured cured coating layer thickness provided in Table 2 was determined by measuring the weight difference of the coated and the uncoated substrate and dividing the weight difference by the surface of the coating layer and the coating composition density.

As shown in FIG. 5A-B, the optical effect layers (OELs) made from the samples E1-E2 according to the present invention exhibited a variation of the elevation angle γ of the pigment particles following a curve reaching a plateau value (regions A and A′). The so-obtained optical effect layers (OELs) comprised neighboring magnetically oriented platelet-shaped magnetic or magnetizable pigment particles having their main axis X substantially parallel to each other in a first region (corresponding to the area A of the magnetic field) of the at least partially cured coating layer (x40) and neighboring magnetically oriented platelet-shaped magnetic or magnetizable pigment particles having their main axis X substantially parallel to each other in a second region (corresponding to the area A′ of the magnetic field) of the at least partially cured coating layer (x40), the magnetically oriented platelet-shaped magnetic or magnetizable pigment particles having a different elevation angle in said first and second regions.

Contrary the optical effect layers (OELs) made from the samples E1-E2 according to the present invention, the optical effect layers (OELs) made from the comparative samples C1-C2 exhibited a variation of the elevation angle γ of the pigment particles following a constantly increasing line with no plateau absolute value.

The optical effect layers (OELs) made from the samples E3 according to the present invention exhibited a constant elevation angle γ over the whole surface of the OEL as a result of an exposure of the coating layer (410) to the magnetic field of the magnetic-field generating device (x40) in one area (shown as A) wherein the magnetic field is substantially homogeneous. The elevation angle γ was much smaller than the angle α as a result of the layer thickness (8 micrometers being smaller than the d50 value of the pigment particles (20 micrometers), i.e. part of the invention).

The optical effect layer (OEL) made from the comparative sample C3 exhibited a constant elevation angle γ over the whole surface of the OEL as a result of an exposure of the coating layer (410) to the magnetic field of the magnetic-field generating device (x40) in one area (shown as A) wherein the magnetic field is substantially homogeneous. However, the elevation angle γ was similar to the angle α as a result of the layer thickness (24 micrometers being larger than the d50 of the pigment particles (20 micrometers, i.e. not part of the invention).

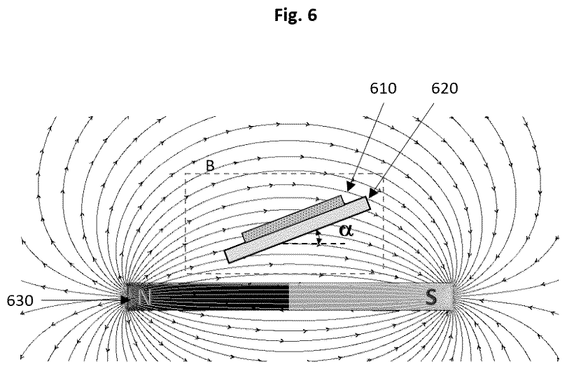

For comparison purposes, FIG. 6 discloses an example according to the co-pending application EP 20194060.8, wherein a coating layer (510) comprising pigment particles is exposed to the magnetic field of a magnetic-field generating device (530) in an area (shown as B) wherein the magnetic field is substantially homogeneous and wherein the substrate (520) carrying the coating layer (510) is provided in said area wherein the magnetic field is substantially homogeneous with an angle α formed by the coating layer (510) and a tangent to magnetic field lines of the magnetic field within the area B wherein the magnetic field is substantially homogeneous, being larger than 0° and smaller than 30° (0°<α<30°) or larger than 150° and smaller than 180° (150°<α<180°), i.e. angles significantly different from those used in the present invention.

1. A method for producing one or more optical effect layers comprising magnetically oriented platelet-shaped magnetic or magnetizable pigment particles on a substrate having a two-dimensional surface, said method comprising the steps of:
a) applying on the substrate surface a radiation curable coating composition comprising platelet-shaped magnetic or magnetizable pigment particles having a main axis X and having a d50 value, said radiation curable coating composition being in a first, liquid state so as to form a coating layer;
b) exposing the coating layer to a magnetic field of a magnetic-field generating device in one or more areas of said magnetic field so as to orient at least a part of the platelet-shaped magnetic or magnetizable pigment particles,
wherein the substrate carrying the coating layer is provided in said one or more areas and wherein an angle α formed by the two-dimensional surface of the substrate at the positions of the particles and a tangent to magnetic field lines of the magnetic field within the one or more areas is larger than or equal to 12° and smaller than or equal to about 75° (12°≤|α|≤75°) or larger than or equal to 105° and smaller than or equal to 168° (105°≤|α|≤168°);
c) partially simultaneously with or subsequently to step b), a step of at least partially curing the coating layer with a curing unit so as to fix the position and orientation of the platelet-shaped magnetic or magnetizable pigment particles in the coating layer so as to produce an at least partially cured coating layer having a thickness T,
wherein the thickness T of the at least partially cured coating layer is smaller than the d50 value of the platelet-shaped magnetic or magnetizable pigment particles, and
wherein neighboring magnetically oriented platelet-shaped magnetic or magnetizable pigment particles have at least their main axis X substantially parallel to each other in one or more regions of the at least partially cured coating layer.

2. The method according to claim 1, wherein the thickness T of the at least partially cured coating layer is smaller than d50*sin(α) (T<d50*(sin α)).

3. The method according to claim 1, wherein the step a) of applying on the substrate surface the radiation curable coating composition is carried out by a printing process selected from the group consisting of screen printing, rotogravure printing and flexography printing.

4. The method according to claim 1, wherein at least a part of the platelet-shaped magnetic or magnetizable pigment particles is constituted by platelet-shaped optically variable magnetic or magnetizable pigment particles.

5. The method according to claim 4, wherein the platelet-shaped optically variable magnetic or magnetizable pigment particles are selected from the group consisting of platelet-shaped magnetic thin-film interference pigments, platelet-shaped magnetic cholesteric liquid crystal pigments, interference coated magnetic pigment particles and mixtures thereof.

6. The method according to claim 4, wherein at least a part of the platelet-shaped magnetic or magnetizable particles is constituted by platelet-shaped magnetic or magnetizable pigment particles exhibiting a metallic color.

7. The method according to claim 1, wherein the magnetic-field generating device is a bar dipole magnet having its magnetic axis substantially parallel to the two-dimensional surface of the substrate and wherein the step b) comprises exposing the coating layer to the magnetic field of said magnetic-field generating device in the one or more areas of said magnetic field wherein the magnetic field does not have a substantially constant magnitude and direction over the entire area or areas of interest, or is not substantially confined to a plane, the magnetically oriented platelet-shaped magnetic or magnetizable pigment particles experiencing different angles α.

8. The method according to claim 1, wherein the step b) comprises exposing the coating layer to the magnetic field of a magnetic-field generating device in the one or more areas of said magnetic field wherein the magnetic field has a substantially constant magnitude and direction over the entire area or areas of interest, or is substantially confined to a plane, the magnetically oriented platelet-shaped magnetic or magnetizable pigment particles experiencing substantially the same angle α.

9. The method according to claim 1, wherein the step b) comprises exposing the coating layer to a magnetic field having a substantially constant magnitude and direction over the entire area or areas of interest, or being substantially confined to a plane, and wherein the magnetic-field generating device comprises two spaced apart bar dipole magnets (M1, M2) having a same magnetic direction and having a same length and two spaced apart pole pieces (P1, P2) having a same length arranged as a rectangular assembly, wherein M1 is not adjacent to and faces M2, P1 is not adjacent to and faces P2, and wherein P1 is placed at a distance corresponding to the length of M1/M2 from P2.

10. The method according to claim 9, wherein the magnetic field lines are substantially parallel to each other in said one or more areas.

11. The method according to claim 1, wherein the one or more optical effect layers are independently made of a single at least partially cured coating layer and comprise magnetically oriented platelet-shaped magnetic or magnetizable pigment particles in said single at least partially cured coating layer, said single at least partially cured coating layer comprising one or more first regions and one or more second regions, wherein said method comprises:
a) applying on the substrate surface described herein the radiation curable coating composition comprising the platelet-shaped magnetic or magnetizable pigment particles described herein so as to form a single coating layer comprising one or more first regions and one or more second regions,
b) exposing the single coating layer to the magnetic field of the magnetic-field generating device with the substrate carrying the single coating layer described herein provided in the one or more areas and with the angle α being larger than or equal to 12° and smaller than or equal to about 75° (12°≤|α|≤75°) or larger than or equal to 105° and smaller than or equal to 168° (105°≤|α|≤168°),
partially simultaneously with or subsequently to the step b), the step c) of at least partially selectively curing the one or more first regions of the single coating layer with the curing unit to fix at least a part of the platelet-shaped magnetic or magnetizable particles in their adopted positions and orientations,
d) exposing the single coating layer to the magnetic field of a second magnetic field so as to orient at least a part of the platelet-shaped magnetic or magnetizable pigment particles in the one or more second regions, wherein the substrate is provided in said one or more areas and wherein an angle α′ formed by the two-dimensional surface of the substrate at the positions of the platelet-shaped magnetic or magnetizable pigment particles and a tangent to magnetic field lines of the second magnetic field within the one or more areas is larger than or equal to 12° and smaller than or equal to 75° (12°≤|α′|≤75°) or larger than or equal to 105° and smaller than or equal to 168° (105°≤|α′|≤168°), wherein the second magnetic-field generating device is the same or is different from the magnetic-field generating device of step b), α′ being different from α; and
partially simultaneously with or subsequently to the step d), the step e) of at least partially curing the single coating layer with the curing unit described herein so as to form the single at least partially cured coating layer, wherein neighboring magnetically oriented platelet-shaped magnetic or magnetizable pigment particles have at least their main axis X substantially parallel to each other in the one or more first regions of the single at least partially cured coating layer, and
neighboring magnetically oriented platelet-shaped magnetic or magnetizable pigment particles have at least their main axis X substantially parallel to each in the one or more second regions of the single at least partially cured coating layer.

12. The method according to claim 1, wherein the one or more optical effect layers comprise magnetically oriented platelet-shaped magnetic or magnetizable pigment particles in the at least partially cured coating layer and comprise magnetically oriented second platelet-shaped magnetic or magnetizable pigment particles in an at least partially cured second coating layer, wherein the at least partially cured second coating layer is either at least partially or fully overlapping the at least partially cured coating layer, or the at least partially cured second coating layer is adjacent to the at least partially cured coating layer, or the at least partially cured second coating layer is spaced apart from the at least partially cured coating layer, said method further comprising:
subsequently to step c), a step d) of applying a second radiation curable coating composition comprising the second platelet-shaped magnetic or magnetizable pigment particles, said second radiation curable coating composition being in a first, liquid state so as to form the second coating layer, wherein said second radiation curable coating composition is the same as or is different from the radiation curable coating composition of step a);
a step e) of exposing the second coating layer to a second magnetic field of a second magnetic-field generating device in one or more areas of said second magnetic field so as to orient at least a part of the second platelet-shaped magnetic or magnetizable pigment particles, wherein the substrate carrying the second coating layer is provided in said one or more areas and wherein an angle α′ formed by the two-dimensional surface of the substrate at the positions of the second platelet-shaped magnetic or magnetizable pigment particles and a tangent to magnetic field lines of the second magnetic field within the one or more areas is larger than or equal to 12° and smaller than or equal to 75° (12°≤|α′|≤75°) or larger than or equal to 105° and smaller than or equal to 168° (105°≤|α′|≤168°),
wherein the second magnetic-field generating device is the same or is different from the magnetic-field generating device of step b), α′ being different from α; and
f) partially simultaneously with or subsequently to the step e) of exposing the second coating layer to the second magnetic field, a step of at least partially curing the second coating layer with a curing unit so as to at least partially fix the position and orientation of the second platelet-shaped magnetic or magnetizable pigment particles in the second coating layer so as to produce the at least partially cured second coating layer,
wherein neighboring magnetically oriented platelet-shaped magnetic or magnetizable pigment particles have at least their main axis X substantially parallel to each other in the at least partially cured coating layer and neighboring magnetically oriented second platelet-shaped magnetic or magnetizable pigment particles have at least their main axis X substantially parallel to each other in the second coating layer,
the magnetically oriented platelet-shaped magnetic or magnetizable pigment particles in the at least partially cured coating layer having a different elevation angle than the magnetically oriented platelet-shaped magnetic or magnetizable pigment particles in the at least partially cured second coating layer.

13. The method according to claim 1 further comprising a step of applying a composition in the form of one or more indicia and a step of at least partially curing or hardening said composition, said one or more indicia being present between the substrate and the at least partially cured coating layer, said steps being carried out prior to the step a) of applying on the substrate surface the radiation curable coating composition.

14. An optical effect layer obtained by the method according to claim 1, the optical effect layer comprising an at least partially cured layer having a thickness T and made from a radiation curable coating composition comprising magnetically oriented platelet-shaped magnetic or magnetizable pigment particles having a main axis X and having a d50 value,
wherein the thickness T of the at least partially cured coating layer is smaller than the d50 value of the platelet-shaped magnetic or magnetizable pigment particles, and
wherein, in one or more regions of said at least partially cured layer, neighboring magnetically oriented platelet-shaped magnetic or magnetizable pigment particles have at least their main axis X substantially parallel to each other.

15. A security document or a decorative article comprising the substrate and the one or more optical effect layers obtained by the method recited in claim 1.

16. A security document or a decorative article comprising the substrate and the one or more optical effect layers recited in claim 14.

17. The method according to claim 3, wherein the printing process is performed using flexography printing.

18. The method according to claim 6, wherein the metallic color is a silver color or a gold color.

19. The method according to claim 11, wherein α′ and α differ by at least 30°.

20. The method according to claim 12, wherein α′ and α differ by at least 30°.
